(19) United States
(12) Patent Application Publication
(10) Pub. No.: US 2025/0119196 A1
(43) Pub. Date: Apr. 10, 2025

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/981,680

(22) Filed: Dec. 16, 2024

Related U.S. Application Data
(63) Continuation of application No. PCT/CN2023/101276, filed on Jun. 20, 2023.

(30) Foreign Application Priority Data
Jun. 27, 2022 (CN) 202210733988.7
Jul. 8, 2022 (CN) 202210804457.2

(51) Int. Cl. H04B 7/06

(52) U.S. Cl. CPC H04B 7/0626; H04B 7/063; H04B 7/0658

(57) ABSTRACT

The present application provides a method and device in a node for wireless communications. A first node receives a first CSI (Channel Status Information) report configuration set; transmits a first information block. The first CSI report configuration set comprises a first CSI report configuration, the first CSI report configuration is used to determine a first CSI report, and the first CSI report comprises a first compress CSI; the first information block comprises the first CSI report; the first CSI report configuration is associated with a first index; the first CSI report occupies a first-type processing unit starting from a first symbol, and a number of the first-type processing unit(s) occupied by the first CSI report is related to the first index. The above method satisfies the demands for processing capability for AI/ML-based CSI report, while avoiding the waste of processing capability and optimizing the system configuration.

### CROSS REFERENCE TO RELATED APPLICATIONS

This application is the continuation of the international patent application No. PCT/CN2023/101276, filed on Jun. 20, 2023, and claims the priority benefit of Chinese Patent Application No. 202210804457.2, filed on Jul. 8, 2022, and claims the priority benefit of Chinese Patent Application No. 202210733988.7, filed on Jun. 27, 2022, the full disclosure of which is incorporated herein by reference.

### BACKGROUND

### Technical Field

The present application relates to transmission methods and devices in wireless communication systems, and in particular to a scheme and device related to CSI (Channel Status Information) in a wireless communication system.

### Related Art

In traditional wireless communications, the UE (User Equipment) reporting may comprise at least one of a variety of auxiliary information, such as CSI, Beam Management related auxiliary information, positioning related auxiliary information and so on, where CSI comprises at least one of a CRI (CSI-RS Resource Indicator), an RI (Rank Indicator), a PMI (Precoding Matrix Indicator) or a CQI (Channel quality indicator).

The network equipment selects appropriate transmission parameters for the UE according to UE reporting, such as a camping cell, an MCS (Modulation and Coding Scheme), a TPMI (Transmitted Precoding Matrix Indicator), a TCI (Transmission Configuration Indication) and other parameters. In addition, the UE reporting can be used to optimize network parameters such as better cell coverage, switching base stations according to UE location, etc.

In NR (New Radio) system, a priority of CSI report is defined, which is used to determine whether CPU (CSI Processing Unit) resources are assigned to corresponding CSI report for updating, or whether the updating of the corresponding CSI report is dropped.

### SUMMARY

The traditional PMI feedback method brings a lot of overhead. In NR R (release) 18, AI (Artificial Intelligence)/ML (Machine Learning)-based CSI report was approved. The applicant has found through researches that there are significant differences between the ML/AI-based CSI calculation and traditional CSI calculation, as they require different processing capabilities and have different demands for the occupation of processing units. Therefore, when the ML/AI-based CSI report technology is introduced, how the UE determines a number of processing unit(s) that need to be occupied by the ML/AI-based CSI report is an issue that needs to be solved.

To address the above problem, the present application provides a solution. It should be noted that while a large number of embodiments of the present application are developed for AI/ML, the present application is also applicable to other schemes, such as traditional codebook-based schemes. In addition, adopting a unified solution for different scenarios, including but not limited to AI/ML-based and codebook-based scenarios, also helps reduce hardware complexity and cost. If no conflict is incurred, embodiments in a first node in the present application and the characteristics of the embodiments are also applicable to a second node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first CSI report configuration set, the first CSI report configuration set comprising a first CSI report configuration, the first CSI report configuration being used to determine a first CSI report, the first CSI report comprising a first compress CSI; and
transmitting a first information block, the first information block comprising the first CSI report;
herein, the first CSI report configuration is associated with a first index; the first CSI report occupies a first-type processing unit starting from a first symbol, and a number of the first-type processing unit(s) occupied by the first CSI report is related to the first index.

In one embodiment, a problem to be solved in the present application comprises: assignment of processing unit(s) occupied by the CSI report. In the above method, a number of the first-type processing unit(s) occupied by the first CSI report is related to the first index, which solves this problem.

In one embodiment, characteristics of the above method include: the first index is related to parameters of the first CSI report configuration indication, such as, but not limited to, a maximum rank, a number of transmitting antenna port(s), a number of sub-band(s), a bandwidth of frequency-domain resources, etc.

In one embodiment, characteristics of the above method include: a number of the first-type processing unit(s) occupied by the first CSI report is related to parameters indicated by the first CSI report configuration, such as, but not limited to, a maximum rank, a number of transmitting antenna port(s), a number of sub-band(s), a bandwidth of frequency-domain resources, etc.

In one embodiment, advantages of the above method comprise: assigning processing units reasonably according to parameters indicated by the first CSI report configuration.

In one embodiment, characteristics of the above method include: the first index is related to characteristics of a radio channel to which a generator of the first CSI report is applicable.

In one embodiment, characteristics of the above method include: a number of the first-type processing unit(s) occupied by the first CSI report is related to characteristics of a radio channel to which a generator of the first CSI report is applicable.

In one embodiment, advantages of the above method comprise: reasonably assigning processing units according to different demands on processing capacity of CSI report generators used for different radio channels.

In one embodiment, advantages of the above method comprise: optimizing the assignment of processing units.

In one embodiment, advantages of the above method comprise: satisfying demands for the processing capacity for CSI report, while avoiding the waste of processing capacity.

According to one aspect of the present application, it is characterized in that a first pre-compress CSI is used as an input of a first function to generate the first compress CSI.

According to one aspect of the present application, it is characterized in that the meaning of the phrase that the first CSI report configuration is associated with a first index includes: the first function is associated with the first index.

In one embodiment, characteristics of the above method include: a number of the first-type processing unit(s) occupied by the first CSI report is related to the first function, such as, but not limited to, a type or range of a radio channel to which the first function is applicable.

In one embodiment, advantages of the above method comprise: assigning the first-type processing unit according to demands of the first function, meeting the demand for processing capability, and avoiding the waste of processing capability.

According to one aspect of the present application, it is characterized in that the first CSI report indicates a first rank, the first rank is not greater than a first rank threshold, and the first rank threshold is related to the first index.

According to one aspect of the present application, it is characterized in that the first CSI report configuration indicates a first frequency-band resource group, and the first frequency-band resource group comprises at least one sub-band; frequency-domain resources which the first CSI report is for comprise the first frequency-band resource group; a number of sub-band(s) comprised in the first frequency-band resource group is not greater than a first sub-band number threshold, and the first sub-band number threshold is related to the first index.

According to one aspect of the present application, it is characterized in that the first CSI report configuration is used to determine a first RS resource group, and a measurement of the first RS resource group is used to generate the first CSI report; the first RS resource group comprises at least one RS resource, and the number of the first-type processing unit(s) occupied by the first CSI report is related to both the first index and a number of RS resources comprised in the first RS resource group.

According to one aspect of the present application, it is characterized in that the first CSI report occupies a second-type processing unit starting from a second symbol.

In one embodiment, characteristics of the above method include: the first-type processing unit and the second-type processing unit each provide different processing capabilities to meet the demands of different CSI report for the CSI processing capacity.

In one embodiment, advantages of the above method comprise: optimizing the configuration of processing capacity and system design.

According to one aspect of the present application, it is characterized in that the first node is a UE.

According to one aspect of the present application, it is characterized in that the first node is a relay node.

The present application provides a method in a second node for wireless communications, comprising:
transmitting a first CSI report configuration set, the first CSI report configuration set comprising a first CSI report configuration, the first CSI report configuration being used to determine a first CSI report, the first CSI report comprising a first compress CSI; and
receiving a first information block, the first information block comprising the first CSI report;
herein, the first CSI report configuration is associated with a first index; the first CSI report occupies a first-type processing unit starting from a first symbol, and a number of the first-type processing unit(s) occupied by the first CSI report is related to the first index.

According to one aspect of the present application, it is characterized in that a first pre-compress CSI is used as an input of a first function to generate the first compress CSI.

According to one aspect of the present application, it is characterized in that the meaning of the phrase that the first CSI report configuration is associated with a first index includes: the first function is associated with the first index.

According to one aspect of the present application, it is characterized in that the first CSI report indicates a first rank, the first rank is not greater than a first rank threshold, and the first rank threshold is related to the first index.

According to one aspect of the present application, it is characterized in that the first CSI report configuration indicates a first frequency-band resource group, and the first frequency-band resource group comprises at least one sub-band; frequency-domain resources which the first CSI report is for comprise the first frequency-band resource group; a number of sub-band(s) comprised in the first frequency-band resource group is not greater than a first sub-band number threshold, and the first sub-band number threshold is related to the first index.

According to one aspect of the present application, it is characterized in that the first CSI report configuration is used to determine a first RS resource group, and a measurement of the first RS resource group is used to generate the first CSI report; the first RS resource group comprises at least one RS resource, and the number of the first-type processing unit(s) occupied by the first CSI report is related to both the first index and a number of RS resources comprised in the first RS resource group.

According to one aspect of the present application, it is characterized in that the first CSI report occupies a second-type processing unit starting from a second symbol.

According to one aspect of the present application, it is characterized in that the second node is a base station.

According to one aspect of the present application, it is characterized in that the second node is a UE.

According to one aspect of the present application, it is characterized in that the second node is a relay node.

The present application provides a first node for wireless communications, comprising:
a first receiver, receiving a first CSI report configuration set, the first CSI report configuration set comprising a first CSI report configuration, the first CSI report configuration being used to determine a first CSI report, the first CSI report comprising a first compress CSI; and
a first transmitter, transmitting a first information block, the first information block comprising the first CSI report;
herein, the first CSI report configuration is associated with a first index; the first CSI report occupies a first-type processing unit starting from a first symbol, and a number of the first-type processing unit(s) occupied by the first CSI report is related to the first index.

The present application provides a second node for wireless communications, comprising:
a second transmitter, transmitting a first CSI report configuration set, the first CSI report configuration set comprising a first CSI report configuration, the first CSI report configuration being used to determine a first CSI report, the first CSI report comprising a first compress CSI; and
a second receiver, receiving a first information block, the first information block comprising the first CSI report;
herein, the first CSI report configuration is associated with a first index; the first CSI report occupies a first-type processing unit starting from a first symbol, and a number of the first-type processing unit(s) occupied by the first CSI report is related to the first index.

In one embodiment, the present application has the following advantages over conventional schemes:
assigning processing units reasonably according to different demands of different CSI report configurations on processing capacity.
assigning processing units reasonably according to different demands of CSI report generators used for different radio channels on processing capacity.
satisfying the demands of AI/ML-based CSI report on processing capability.
satisfying the demands of processing capacity while avoiding the waste of processing capacity.
respectively configuring different processing units for CSI report quantities with different processing capacity demands, optimizing the system configuration.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first CSI report configuration set and a first information block according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of transmission according to one embodiment of the present application;

FIG. 6 illustrate a schematic diagram of a number of first-type processing unit(s) occupied by a first CSI report being related to a first index according to one embodiment of the present application;

FIG. 7 illustrates a schematic diagram of a measurement for a first RS resource group being used to generate a first CSI report according to one embodiment of the present application;

FIG. 8 illustrates a schematic diagram of frequency-domain resources which a first CSI report is for comprising a first frequency-band resource group according to one embodiment of the present application;

FIG. 9 illustrates a schematic diagram of a processing system based on artificial intelligence or machine learning according to one embodiment of the present application;

FIG. 10 illustrates a schematic diagram of a first function according to one embodiment of the present application;

FIG. 11 illustrates a schematic diagram of a second function according to one embodiment of the present application;

FIG. 12 illustrates a schematic diagram of relations among a first pre-compress CSI, a first compress CSI, a first function and a second function according to one embodiment of the present application;

FIG. 13 illustrates a schematic diagram of a first function being associated with a first index according to one embodiment of the present application;

FIG. 14 illustrates a schematic diagram of a first rank threshold being related to a first index according to one embodiment of the present application;

FIG. 15 illustrates a schematic diagram of a first sub-band number threshold being related to the first index according to one embodiment of the present application;

FIG. 16 illustrate a schematic diagram of a number of first-type processing unit(s) occupied by a first CSI report being related to both a first index and a number of RS resources comprised in a first RS resource group according to one embodiment of the present application;

FIG. 17 illustrates a schematic diagram of a first CSI report occupying a second-type processing unit starting from a second symbol according to one embodiment of the present application;

FIG. 18 illustrates a schematic diagram of a number of second-type processing unit(s) occupied by a first CSI report being related to a number of RS resources comprised in a first RS resource group according to one embodiment of the present application;

FIG. 19 illustrates a structure block diagram of a processor in a first node according to one embodiment of the present application;

FIG. 20 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

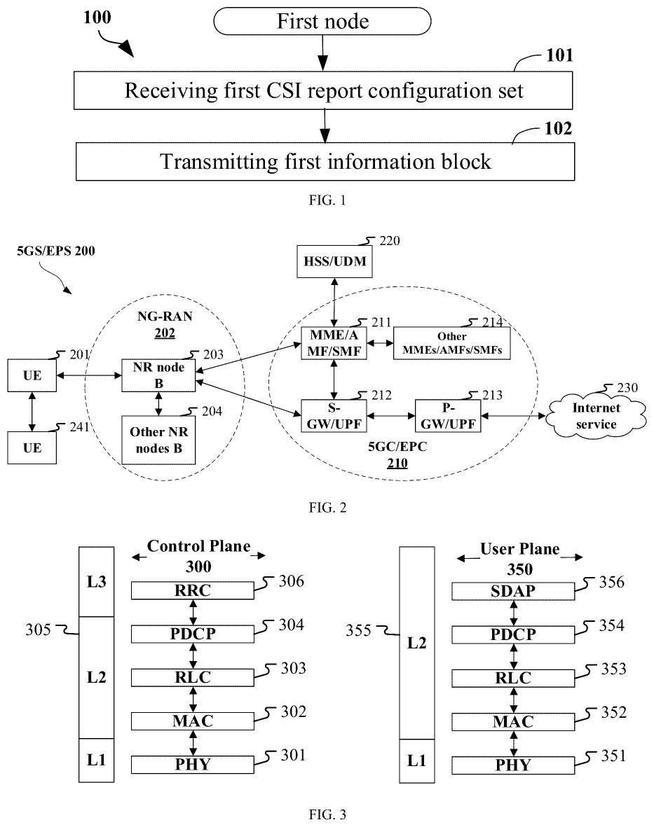

Embodiment 1 illustrates a flowchart of a first CSI report configuration set and a first information block according to one embodiment of the present application, as shown in FIG. 1. In 100 illustrated by FIG. 1, each box represents a step. And in particular, the order of steps in boxes does not represent a specific chronological order between the steps.

In Embodiment 1, the first node in the present application receives a first CSI report configuration set in step 101; transmits a first information block in step 102. Herein, the first CSI report configuration set comprises a first CSI report configuration, the first CSI report configuration is used to determine a first CSI report, and the first CSI report comprises a first compress CSI; the first information block comprises the first CSI report; the first CSI report configuration is associated with a first index; the first CSI report occupies a first-type processing unit starting from a first symbol, and a number of the first-type processing unit(s) occupied by the first CSI report is related to the first index.

In one embodiment, the CSI refers to Channel State Information.

In one embodiment, the CSI comprises channel information.

In one embodiment, the CSI comprises a channel matrix.

In one embodiment, the CSI comprises information about a channel matrix.

In one embodiment, the CSI comprises amplitude and phase information of an element in a channel matrix.

In one embodiment, the CSI comprises an eigenvector.

In one embodiment, the CSI comprises information of an eigenvector.

In one embodiment, the CSI comprises amplitude and phase information of an element in an eigenvector.

In one embodiment, the CSI comprises an eigenvector of a channel matrix.

In one embodiment, the CSI comprises amplitude and phase information of an element in an eigenvector in a channel matrix.

In one embodiment, the first CSI report configuration is carried by a higher-layer signaling.

In one embodiment, the first CSI report configuration is carried by an RRC (Radio Resource Control) signaling.

In one embodiment, the first CSI report configuration is carried by an IE (Information Element).

In one embodiment, the first CSI report configuration is an IE.

In one embodiment, the first CSI report configuration is an IE, and a name of the first CSI report configuration comprises “CSI-ReportConfig”.

In one embodiment, the first CSI report configuration comprises information in all or partial fields in a CSI-ReportConfig IE.

In one embodiment, the first CSI report configuration is a CSI-ReportConfig IE.

In one embodiment, the first CSI report configuration is periodic.

In one embodiment, the first CSI report configuration is semi-persistent.

In one embodiment, the first CSI report configuration is aperiodic.

In one embodiment, the first CSI report configuration is identified by a CSI-ReportConfigId.

In one embodiment, the first CSI report configuration comprises at least one CSI report configuration.

In one embodiment, the first CSI report configuration set consists of the first CSI report configuration.

In one embodiment, the first CSI report configuration set comprises at least one CSI report configuration other than the first CSI report configuration.

In one embodiment, any CSI report configuration in the first CSI report configuration set is carried by a higher-layer signaling.

In one embodiment, any CSI report configuration in the first CSI report configuration set is carried by an RRC signaling.

In one embodiment, any CSI report configuration in the first CSI report configuration set is carried by an IE.

In one embodiment, any CSI report configuration in the first CSI report configuration set is an IE.

In one embodiment, any CSI report configuration in the first CSI report configuration set comprises information in all or partial fields in a CSI-ReportConfig IE.

In one embodiment, there exist two CSI report configurations in the first CSI report configuration being carried by different IEs.

In one embodiment, any two CSI report configurations in the first CSI report configuration are carried by different IEs.

In one embodiment, there exist two CSI report configurations in the first CSI report configuration being carried by a same IE.

In one embodiment, any two CSI report configurations in the first CSI report configuration are carried by a same IE.

In one embodiment, any CSI report configuration in the first CSI report configuration set is identified by a CSI-ReportConfigId.

In one embodiment, CSI-ReportConfigIds of any two CSI report configurations in the first CSI report configuration set are different.

In one embodiment, the first CSI report is a CSI report for the first CSI report configuration.

In one embodiment, the first CSI report comprises one or more CSI report quantities.

In one embodiment, any CSI report quantity comprised in the first CSI report is one of compressed CSI, CQI (Channel Quality Indicator), PMI (Precoding Matrix Indicator), CRI (CSI-RS Resource Indicator), LI (Layer Indicator), RI (Rank Indicator), SSBRI (SS/PBCH Block Resource Indicator), L1-RSRP (Layer 1 Reference Signal Received Power), L1-SSINR (Signal-to-Interference and Noise Ratio), capability index or capability set index.

In one embodiment, any CSI report quantity comprised in the first CSI report is one of compressed CSI, a CQI, a PMI, or an RI.

In one embodiment, the compressed CSI comprises one or more of a compressed PMI, a compressed channel matrix, a compressed eigenvector, compressed channel matrix information, a compressed channel covariance matrix, or a compressed channel covariance matrix information.

In one embodiment, the compressed CSI comprises at least one of a compressed channel matrix or compressed eigenvector.

In one embodiment, the first CSI report configuration comprises a first higher-layer parameter, and a name of the first higher-layer parameter comprises “resourcesForChannelMeasurement”; the first node acquires a channel measurement for calculating the first CSI report based on RS (Reference Signal) resources indicated by the first higher-layer parameter.

In one subembodiment of the above embodiment, RS resources indicated by the first higher-layer parameter comprise CSI-RS (Channel State Information-Reference Signal) resources.

In one subembodiment of the above embodiment, RS resources indicated by the first higher-layer parameter comprise NZP (Non-Zero-Power) CSI-RS resources.

In one subembodiment of the above embodiment, RS resources indicated by the first higher-layer parameter comprise SS (Synchronization Signal)/PBCH (Physical Broadcast Channel) Block resources.

In one embodiment, the first CSI report configuration comprises a second higher-layer parameter, and a name of the second higher-layer parameter includes “ResourcesForInterference”; the first node acquires an interference measurement for calculating the first CSI report based on resources indicated by the second higher-layer parameter.

In one subembodiment of the above embodiment, the resources indicated by the second higher-layer parameter comprise CSI-IM (Channel State Information-Interference Measurement) resources.

In one subembodiment of the above embodiment, the resources indicated by the second higher-layer parameter comprise NZP CSI-RS resources.

In one embodiment, the first CSI report configuration comprises a third higher-layer parameter, and a name of the third higher-layer parameter includes “reportQuantity”; the third higher-layer parameter indicates a CSI report quantity comprised in the first CSI report.

In one subembodiment of the above embodiment, the third higher-layer parameter indicates which one or more CSI report quantities in compressed CSI, CQI, PMI, CRI, LI, RI, SSBRI, L1-RSRP, L1-SSINR, capability index, or capability set index are comprised in the first CSI report.

In one embodiment, the first CSI report configuration is used to determine time-frequency resources for transmitting the first CSI report.

In one embodiment, the first CSI report configuration is used to determine PUCCH (Physical Uplink Control Channel) resources bearing the first CSI report.

In one embodiment, the meaning of the phrase that the first CSI report configuration is used to determine a first CSI report includes: the first CSI report configuration is used to determine: an RS resource group used to acquire a channel measurement for calculating the first CSI report.

In one embodiment, the meaning of the phrase that the first CSI report configuration is used to determine a first CSI report includes: the first CSI report configuration is used to determine: a resource group used to acquire an interference measurement for calculating the first CSI report.

In one embodiment, the meaning of the phrase that the first CSI report configuration is used to determine a first CSI report includes: the first CSI report configuration is used to indicate which CSI report quantities are comprised in the first CSI report.

In one embodiment, the meaning of the phrase that the first CSI report configuration is used to determine a first CSI report includes: the first CSI report configuration indicates a value of each higher-layer parameter in a higher-layer parameter group corresponding to the first CSI report.

In one embodiment, a higher-layer parameter group corresponding to a CSI report comprises part or all of “resourcesForChannelMeasurement”, “csi-IM-ResourcesForInterference”, “nzp-CSI-RS-ResourcesForInterference”, “reportQuantity”, “reportConfigType” “reportFreqConfiguration”, “timeRestrictionForChannelMeasures”, “timeRestrictionForInterferenceMeasures”, “cqi-Table”, “sub-bandSize”, “codebookConfig”, “groupBasedBeamReporting”, or “non-PMI-PortIndication”.

In one embodiment, the first CSI report is generated according to the first CSI report configuration.

In one embodiment, the first CSI report is generated and transmitted according to the first CSI report configuration.

In one embodiment, the first CSI report comprises an RI.

In one embodiment, the RI comprised in the first CSI report indicates a rank.

In one embodiment, the RI comprised in the first CSI report indicates a number of layers.

In one embodiment, the layer refers to MIMO (Multiple Input Multiple Output) layer.

In one embodiment, the first CSI report comprises at least one CQI.

In one embodiment, the first CSI report comprises a wideband CQI.

In one embodiment, the first CSI report comprises at least one sub-band CQI.

In one embodiment, the first CSI report is non-codebook based.

In one embodiment, the first CSI report is generated based on artificial intelligence or machine learning.

In one embodiment, the first CSI report is generated based on neural network.

In one embodiment, the first CSI report is generated based on CNN (Conventional Neural Network).

In one embodiment, the first compress CSI is non-codebook based.

In one embodiment, the first compress CSI is generated based on artificial intelligence or machine learning.

In one embodiment, the first compress CSI is generated based on neural network.

In one embodiment, the first compress CSI is generated based on CNN.

In one embodiment, CSI recovered by a target receiver of the first compress CSI according to the first compress CSI is not available to the first node.

In one embodiment, the first compress CSI is used for precoding, and the first compress CSI does not comprise a codeword index.

In one embodiment, the first compress CSI comprises at least one bit block, and any bit block in the at least one bit block comprises multiple bits.

In one embodiment, the first compress CSI comprises at least one matrix.

In one subembodiment of the above embodiment, an element of any one of the at least one matrix is a complex number.

In one subembodiment of the above embodiment, an element of any matrix in the at least one matrix is a real number.

In one embodiment, the first compress CSI comprises a PMI.

In one embodiment, the first compress CSI comprises a compressed PMI.

In one embodiment, the first compress CSI comprises at least one of CQI or RI.

In one embodiment, the first compress CSI comprises one or multiple of CQI, a CRI or an RI.

In one embodiment, the first compress CSI comprises at least one channel matrix.

In one embodiment, the first compress CSI comprises information of at least one channel matrix.

In one embodiment, the first compress CSI comprises at least one compressed channel matrix.

In one embodiment, the first compress CSI comprises at least one eigenvector.

In one embodiment, the first compress CSI comprises information of at least one eigenvector.

In one embodiment, the first compress CSI comprises at least one compressed eigenvector.

In one embodiment, the eigenvector comprises an eigenvector of a channel matrix.

In one embodiment, the eigenvector comprises an eigenvector of a covariance matrix.

In one embodiment, the matrix comprises vector.

In one embodiment, the first information block is carried by a physical-layer signaling.

In one embodiment, the first information block is carried by a MAC CE.

In one embodiment, the first information block comprises Uplink control information (UCI).

In one embodiment, the first information block comprises CSI.

In one embodiment, the first index is a non-negative integer.

In one embodiment, the meaning of the phrase that the first CSI report configuration is associated with a first index includes: the first index is used to identify the first CSI report configuration.

In one embodiment, the meaning of the phrase that the first CSI report configuration is associated with a first index includes: the first index is a CSI-ReportConfiguraId of the first CSI report configuration.

In one embodiment, the meaning of the phrase that the first CSI report configuration is associated with a first index includes: the first index is used to determine a type or range of a radio channel to which a generator of the first CSI report is applicable.

In one embodiment, the meaning of the phrase that the first CSI report configuration is associated with a first index includes: the first index is used to determine a type or range of a radio channel to which a generator of the first compress CSI is applicable.

In one embodiment, the meaning of the phrase that the first CSI report configuration is associated with a first index includes: the first index is used to indicate a range or type of a radio channel to which a generator of the first compress CSI is applicable.

In one embodiment, the first CSI report configuration set comprises at least one CSI report configuration other than the first CSI report configuration, and each CSI report configuration in the first CSI report configuration set is associated with the first index.

In one embodiment, the meaning of a CSI report configuration being associated with the first index includes: the first index is used to identify the CSI report configuration.

In one embodiment, the meaning of a CSI report configuration being associated with the first index includes: the first index is used to determine a type or range of a radio channel to which a generator of a CSI report is applicable for the CSI report configuration.

In one embodiment, the meaning of a CSI report configuration being associated with the first index includes: the first function is associated with the first index; the first function is used to generate a CSI report for the CSI report configuration.

In one embodiment, the meaning of a CSI report configuration being associated with the first index includes: the first function is associated with the first index; the first function is used to generate a compress CSI comprised in a CSI report for the CSI report configuration.

In one embodiment, the first CSI report does not occupy the first-type processing unit before the first symbol.

In one embodiment, the first symbol is an OFDM (Orthogonal Frequency Division Multiplexing) symbol.

In one embodiment, the first symbol is an SC-FDMA (Single Carrier-Frequency Division Multiple Access) symbol.

In one embodiment, the first-type processing unit comprises a CSI processing unit.

In one embodiment, the first-type processing unit is a CSI processing unit.

In one embodiment, the first-type processing unit is another type of processing unit different from a CSI processing unit.

In one embodiment, the first-type processing unit is a universal processing unit.

In one embodiment, the first-type processing unit is used to process a first-type CSI report, and the first CSI report is the first-type CSI report.

In one subembodiment of the above embodiment, the first-type CSI report refers to a compress CSI.

In one subembodiment of the above embodiment, the first-type processing unit is used to process a second-type CSI report, where the first-type CSI report is not the second-type CSI report, and the second-type CSI report does not indicate a compress CSI.

In one subembodiment of the above embodiment, the first-type processing unit is not used to process a second-type CSI report, where the first-type CSI report is not the second-type CSI report, and the second-type CSI report does not indicate a compress CSI.

In one embodiment, the number of the first-type processing unit(s) occupied by the first CSI report is a positive integer.

In one embodiment, the meaning of the phrase that a number of the first-type processing unit(s) occupied by the first CSI report is related to the first index includes: the first index is used to determine the number of the first-type processing unit(s) occupied by the first CSI report.

In one embodiment, the meaning of the phrase that a number of the first-type processing unit(s) occupied by the first CSI report is related to the first index includes: the first index is used to determine a first parameter, and the first parameter is used to determine the number of first-type processing unit(s) occupied by the first CSI report.

In one embodiment, the meaning of the phrase that a number of the first-type processing unit(s) occupied by the first CSI report is related to the first index includes: the first index is used to identify the first CSI report configuration; the first CSI report configuration is used to determine a first parameter, and the first parameter is used to determine the number of first-type processing unit(s) occupied by the first CSI report.

In one subembodiment of the above embodiment, the first CSI report configuration indicates the first parameter.

In one subembodiment of the above embodiment, the first CSI report configuration indicates a first frequency-band resource group, and the first frequency-band resource group comprises at least one sub-band; the first parameter is equal to a number of sub-band(s) comprised in the first frequency-band resource group.

In one subembodiment of the above embodiment, the first CSI report configuration indicates a first frequency-band resource group; the first parameter is related to a bandwidth covered by the first frequency-band resource group.

In one reference embodiment of the above subembodiment, the first parameter is equal to a bandwidth denoted by a number of subcarrier(s) covered by the first frequency-band resource group.

In one reference embodiment of the above subembodiment, the first parameter is equal to a bandwidth denoted by a number of Resource Block(s) (RB(s)) covered by the first frequency-band resource group.

In one reference embodiment of the above subembodiment, the first parameter is equal to a bandwidth denoted by MHz or KHz covered by the first frequency-band resource group.

In one subembodiment of the above embodiment, the first CSI report configuration is used to determine a first RS resource group, and a measurement of the first RS resource group is used to generate the first CSI report; the first RS resource group comprises at least one RS resource, and one RS resource comprises at least one RS port; the first parameter is equal to a maximum number of RS ports comprised in RS resources in the first RS resource group.

In one subembodiment of the above embodiment, the number of the first-type processing unit(s) occupied by the first CSI report varies with the first parameter.

In one subembodiment of the above embodiment, the first parameter is a non-negative integer, and the number of the first-type processing unit(s) occupied by the first CSI report increases with the increase of the first parameter.

In one subembodiment of the above embodiment, the first parameter is a non-negative integer; when the first parameter is equal to A1, the number of the first-type processing unit(s) occupied by the first CSI report is equal to B1; when the first parameter is equal to A2, the number of the first-type processing unit(s) occupied by the first CSI report is equal to B2; the A1 is greater than the A2, and the B1 is not less than the B2.

In one subembodiment of the above embodiment, the first parameter is a non-negative integer, and the number of the first-type processing unit(s) occupied by the first CSI report is linearly correlated with the first parameter, and a linear coefficient between the number of the first-type processing unit(s) occupied by the first CSI report and the first parameter is a positive real number.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the gNB 203.

In one embodiment, a radio link between the UE 201 and the gNB 203 comprises a cellular network link.

In one embodiment, a transmitter of the first CSI report configuration set comprises the gNB 203.

In one embodiment, a receiver of the first CSI report configuration set comprises the UE 203.

In one embodiment, a transmitter of the first information block comprises the UE 201.

In one embodiment, a receiver of the first information block comprises the gNB 203.

In one embodiment, the UE 201 supports CNN-based CSI compression.

In one embodiment, the UE 201 supports AI/ML-based CSI compression.

In one embodiment, the UE 201 supports the generation of a trained model or partial parameters in the model using training data.

In one embodiment, the UE 201 supports determining at least partial parameters of CNN used for CSI compression through training.

In one embodiment, the gNB 203 supports decompression of CSI using AI or ML.

### Embodiment 3

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first CSI report configuration set is generated at the RRC sublayer 306.

In one embodiment, the first information block is generated at the PHY 301 or the PHY 351.

In one embodiment, the higher layer in the present application refers to a layer above the physical layer.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives the first CSI report configuration set; transmits the first information block. The first CSI report configuration set comprises a first CSI report configuration, the first CSI report configuration is used to determine a first CSI report, and the first CSI report comprises a first compress CSI; the first information block comprises the first CSI report; the first CSI report configuration is associated with a first index; the first CSI report occupies a first-type processing unit starting from a first symbol, and a number of the first-type processing unit(s) occupied by the first CSI report is related to the first index.

In one embodiment, the second communication device 450 comprises a memory that stores a computer readable instruction program. The computer readable instruction program generates an action when executed by at least one processor. The action includes: receiving the first CSI report configuration set; transmitting the first information block.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits the first CSI report configuration set; receives the first information block. The first CSI report configuration set comprises a first CSI report configuration, the first CSI report configuration is used to determine a first CSI report, and the first CSI report comprises a first compress CSI; the first information block comprises the first CSI report; the first CSI report configuration is associated with a first index; the first CSI report occupies a first-type processing unit starting from a first symbol, and a number of the first-type processing unit(s) occupied by the first CSI report is related to the first index.

In one embodiment, the first communication device 410 comprises a memory that stores a computer readable instruction program. The computer readable instruction program generates an action when executed by at least one processor. The action includes: transmitting the first CSI report configuration set; receiving the first information block.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first CSI report configuration set; at least one of the antenna 420, the transmitter 418, the transmitting processor 416, the multi-antenna transmitting processor 471, the controller/processor 475, or the memory 476 is used to transmit the first CSI report configuration set.

In one embodiment, at least one of the antenna 420, the receiver 418, the receiving processor 470, the multi-antenna receiving processor 472, the controller/processor 475 or the memory 476 is used to receive the first information block; at least one of the antenna 452, the transmitter 454, the transmitting processor 468, the multi-antenna transmitting processor 457, the controller/processor 459, the memory 460, or the data source 467 is used to transmit the first information block.

In one embodiment, at least one of the antenna 452, the receiver 454, the receiving processor 456, the multi-antenna receiving processor 458, the controller/processor 459, the memory 460, or the data source 467 is used for a measurement of the first RS resource group; at least one of the antenna 420, the transmitter 418, the transmitting processor 416, the multi-antenna transmitting processor 471, the controller/processor 475, or the memory 476 is used to transmit an RS in at least one RS resource in the first RS resource group.

### Embodiment 5

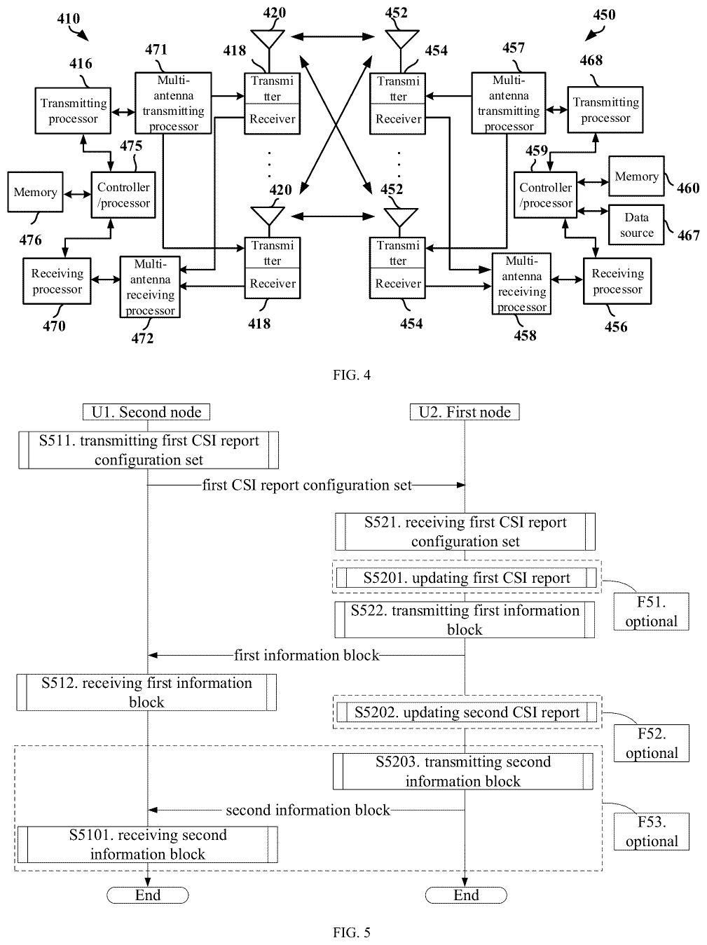

Embodiment 5 illustrates a flowchart of transmission according to one embodiment of the present application, as shown in FIG. 5. In FIG. 5, a second node U1 and a first node U2 are communication nodes transmitted via an air interface. In FIG. 5, each step in block F51 to block F53 is optional.

The second node U1 transmits a first CSI report configuration set in step S511; receives a first information block in step S512; receives a second information block in step S5101.

The first node U2 receives a first CSI report configuration set in step S521; updates a first CSI report in step S5201; transmits a first information block in step S522; and updates a second CSI report in step S5202; transmits a second information block in step S5203.

In embodiment 5, the first CSI report configuration set comprises a first CSI report configuration, the first CSI report configuration is used by the first node U2 to determine the first CSI report, and the first CSI report comprises a first compress CSI; the first information block comprises the first CSI report; the first CSI report configuration is associated with a first index; the first CSI report occupies a first-type processing unit starting from a first symbol, and a number of the first-type processing unit(s) occupied by the first CSI report is related to the first index.

In one embodiment, the first node U2 is the first node in the present application.

In one embodiment, the second node U1 is the second node in the present application.

In one embodiment, an air interface between the second node U1 and the first node U2 comprises a radio interface between a base station and a UE.

In one embodiment, an air interface between the second node U1 and the first node U2 comprises a radio interface between a relay node and a UE.

In one embodiment, an air interface between the second node U1 and the first node U2 comprises a radio interface between a UE and a UE.

In one embodiment, the second node U1 is a serving cell maintenance base station of the first node U2.

In one embodiment, the first CSI report configuration is transmitted in a Physical Downlink Shared Channel (PDSCH).

In one embodiment, any CSI report configuration in the first CSI report configuration set is transmitted in a PDSCH.

In one embodiment, there exist two CSI report configurations being transmitted in different PDSCHs in the first CSI report configuration set.

In one embodiment, there exist two CSI report configurations being transmitted in a same PDSCH in the first CSI report configuration set.

In one embodiment, the first information block is transmitted in a Physical Uplink Shared CHannel (PUSCH).

In one embodiment, the first information block is transmitted in a PUCCH.

In one embodiment, the step in block F51 in FIG. 5 exists, and the above method in a first node for wireless communications comprises: the first node updates the first CSI report.

In one embodiment, the first node updates at least one CSI report quantity comprised in the first CSI report.

In one embodiment, the first node updates each CSI report quantity comprised in the first CSI report.

In one embodiment, steps in block F53 in FIG. 53 exist, and the above method in a first node for wireless communications comprises: transmitting a second information block, the second information block comprising a second CSI report; herein, a second CSI report configuration is used by the first node U2 to determine the second CSI report, and the second CSI report configuration is a CSI report configuration different from the first CSI report configuration in the first CSI report configuration set; the second CSI report comprises a second compress CSI, and a second pre-compress CSI is used as an input of the first function by the first node U2 to generate the second compressed CSI; the second CSI report configuration is associated with the first index; the second CSI report occupies the first-type processing unit starting from a third symbol, and a number of first-type processing unit(s) occupied by the second CSI report is related to the first index.

In one embodiment, steps in block F53 in FIG. 53 exist, and the above method in a second node for wireless communications comprises: receiving the second information block.

In one embodiment, the second CSI report configuration is any CSI report configuration different from the first CSI report configuration in the first CSI report configuration set.

In one embodiment, the number of the first-type processing unit(s) occupied by the second CSI report is related to a type or range of a radio channel to which the first function is applicable.

In one embodiment, a type or range of a radio channel to which the first function is applicable is used to determine the number of the first-type processing unit(s) of occupied by the second CSI report.

In one embodiment, the second CSI report indicates a second rank, the second rank is not greater than a second rank threshold, the second rank threshold is related to the first index, and the second rank threshold is used to determine the number of the first-type processing unit(s) occupied by the second CSI report.

In one embodiment, the second rank threshold is related to a type or range of a radio channel to which the first function is applicable.

In one embodiment, the second CSI report configuration indicates a second frequency-band resource group, and the second frequency-band resource group comprises at least one sub-band; frequency-domain resources which the second CSI report is for comprise the second frequency-band resource group; a number of sub-band(s) comprised in the second frequency-band resource group is not greater than a second sub-band number threshold, the second sub-band number threshold is related to the first index, and the second sub-band number threshold is used to determine the number of the first-type processing unit(s) occupied by the second CSI report.

In one embodiment, the second sub-band number threshold is related to a type or range of a radio channel to which the first function is applicable.

In one embodiment, the second CSI report configuration is used to determine a second RS resource group, and the second RS resource group comprises at least one RS resource; a measurement for the second RS resource group is used by the first node U2 to generate the second CSI report.

In one embodiment, a measurement for the second RS resource group is used to obtain a channel measurement for generating the second CSI report.

In one embodiment, any RS resource in the second RS resource group is a CSI-RS resource or an SS/PBCH block resource.

In one embodiment, the second node U1 transmits an RS in at least one RS resource in the second RS resource group; the first node U2 receives an RS in at least one RS resource in the second RS resource group.

In one embodiment, the third symbol is an OFDM symbol.

In one embodiment, the third symbol is earlier than the first symbol.

In one embodiment, the third symbol is later than the first symbol.

In one embodiment, time-domain resources in which the first CSI report occupies the first-type processing unit overlap with time-domain resources in which the second CSI report occupies the first-type processing unit.

In one embodiment, time-domain resources in which the first CSI report occupies the first-type processing unit are mutually orthogonal to time-domain resources in which the second CSI report occupies the first-type processing unit.

In one embodiment, the second information block is transmitted in a PUSCH.

In one embodiment, the second information block is transmitted in a PUCCH.

In one embodiment, the first CSI report and the second CSI report are for a same BWP (bandwidth part).

In one embodiment, the first CSI report and the second CSI report are for a same carrier.

In one embodiment, the first CSI report and the second CSI report are for a same serving cell.

In one embodiment, the first CSI report and the second CSI report are for different BWPs.

In one embodiment, the first CSI report and the second CSI report are for different carriers.

In one embodiment, the first CSI report and the second CSI report are for different serving cells.

In one embodiment, the step in block F52 in FIG. 5 exists, and the above method in a first node for wireless communications comprises: the first node updates the second CSI report.

In one embodiment, steps in block F52 and block F53 in FIG. 5 exist.

In one embodiment, the second CSI report configuration is used to determine: an RS resource group used to acquire a channel measurement for calculating the second CSI report.

In one embodiment, the second CSI report configuration is used to determine: a resource group used to acquire an interference measurement for calculating the second CSI report.

In one embodiment, the second CSI report configuration is used to indicate which CSI report quantities are comprised in the second CSI report.

### Embodiment 6

Embodiment 6 illustrate a schematic diagram of a number of first-type processing unit(s) occupied by a first CSI report being related to a first index according to one embodiment of the present application, as shown in FIG. 6. In embodiment 6, the first CSI report configuration indicates a first rank set, and the first rank set comprises at least one rank; the first CSI report indicates a first rank, and the first rank belongs to the first rank set; the meaning of the phrase that a number of the first-type processing unit(s) occupied by the first CSI report is related to the first index includes: the number of the first-type processing unit(s) occupied by the first CSI report is related to a maximum value in the first rank set.

In one embodiment, all candidate values of the first rank consist the first rank set.

In one embodiment, a rank indicated by any CSI report for the first CSI report configuration belongs to the first rank set.

In one embodiment, the first CSI report configuration comprises a fourth higher-layer parameter, and the fourth higher-layer parameter indicates R bits r₀, . . . , r_{R-1}, R being a positive integer greater than 1; r₀ is LSB (Least Significant Bit), and r_{R-1} is MSB (Most Significant Bit); for any non-negative integer j less than R, if rⱼ is equal to a first bit value, the first rank set comprises rank j+1; if the rⱼ is not equal to the first bit value, the first rank set does not comprise rank j+1.

In one subembodiment of the above embodiment, the first bit value is equal to 1.

In one subembodiment of the above embodiment, the first bit value is equal to 0.

In one subembodiment of the above embodiment, a name of the fourth higher-layer parameter includes “ri-restriction”.

In one embodiment, a maximum value in the first rank set is used to determine the number of first-type processing unit(s) occupied by the first CSI report.

In one embodiment, the number of the first-type processing unit(s) occupied by the first CSI report varies with a maximum value in the first rank set.

In one embodiment, the number of the first-type processing unit(s) occupied by the first CSI report increases with the increase of a maximum value in the first rank set.

In one embodiment, the number of the first-type processing unit(s) occupied by the first CSI report is linearly correlated with a maximum value in the first rank set, and a linear coefficient between the number of the first-type processing unit(s) occupied by the first CSI report and a maximum value in the first rank set is a positive real number.

In one subembodiment of the above embodiment, a linear coefficient between the number of the first-type processing unit(s) occupied by the first CSI report and a maximum value in the first rank set is equal to 1.

In one embodiment, the number of the first-type processing unit(s) occupied by the first CSI report is equal to a maximum value in the first rank set.

In one embodiment, when a maximum value in the first rank set is equal to A1, the number of the first-type processing unit(s) occupied by the first CSI report is equal to B1; when a maximum value in the first rank set is equal to A2, the number of the first-type processing unit(s) occupied by the first CSI report is equal to B2; the A1 is greater than the A2, and the B1 is not less than the B2.

### Embodiment 7

Embodiment 7 illustrates a schematic diagram of a measurement for a first RS resource group being used to generate a first CSI report according to one embodiment of the present application, as shown in FIG. 7. In embodiment 7, the first CSI report configuration is used by the first node to determine a first RS (Reference Signal) resource group, and the first RS resource group comprises at least one RS resource; a measurement of the first RS resource group is used by the first node to generate the first CSI report.

In one embodiment, a measurement for an RS resource group refers to: a measurement for an RS transmitted in RS resources in the RS resource group.

In one embodiment, the measurement for the first RS resource group comprises: a measurement for an RS transmitted in each RS resource in the first RS resource group.

In one embodiment, the measurement for the first RS resource group comprises: a measurement for an RS transmitted in at least one RS resource in the first RS resource group.

In one embodiment, the first CSI report configuration indicates the first RS resource group.

In one embodiment, an RS resource group for channel measurement indicated by the first CSI report configuration comprises the first RS resource group.

In one embodiment, the first CSI report configuration and a first higher-layer information block are used together to determine the first RS resource group.

In one subembodiment of the above embodiment, the first higher-layer information block is carried by an IE.

In one embodiment, a name of an IE carrying the first higher-layer information block comprises “CSI-AperiodicTriggerStateList”.

In one subembodiment of the above embodiment, the first CSI report configuration and the first higher-layer information are respectively carried by different IEs.

In one subembodiment of the above embodiment, the first CSI report configuration indicates M RS resource groups, M being a positive integer greater than 1, and the first RS resource group is one of the M RS resource groups; the first higher-layer information block indicates the first RS resource group from the M RS resource groups.

In one embodiment, the first node acquires a channel measurement used for calculating the first CSI report based on the first RS resource group.

In one embodiment, the first node acquires a channel measurement used for calculating the first CSI report only based on the first RS resource group.

In one embodiment, the first node acquires a channel measurement for calculating the first CSI report based on that the first RS resource group is not later than a latest transmission occasion of CSI reference resources of first CSI report.

In one embodiment, the first node acquires a channel measurement for calculating the first CSI report only based on that the first RS resource group is not later than a latest transmission occasion of CSI reference resources of first CSI report.

In one embodiment, a first higher-layer parameter comprised in the first CSI report configuration indicates the first RS resource group, and a name of the first higher-layer parameter includes “resourcesForChannelMeasurement”.

In one embodiment, the first RS resource group comprises a CSI-RS resource set.

In one embodiment, the first RS resource group is a CSI-RS resource set.

In one embodiment, the first RS resource group is an NZP CSI-RS resource set.

In one embodiment, the first RS resource group is identified by an NZP-CSI-RS-ResourceSetId.

In one embodiment, the first RS resource group is identified by a CSI-SSB-ResourceSetId.

In one embodiment, the first RS resource group only comprises one RS resource.

In one embodiment, the first RS resource group comprises multiple RS resources.

In one embodiment, RS resources in the first RS resource group comprise CSI-RS resources.

In one embodiment, RS resources in the first RS resource group comprise SS/PBCH block resources.

In one embodiment, any RS resource in the first RS resource group is a CSI-RS resource.

In one embodiment, any RS resource in the first RS resource group is identified by an NZP-CSI-RS-ResourceId.

In one embodiment, any RS resource in the first RS resource group is an SS/PBCH block resource.

In one embodiment, any RS resource in the first RS resource group is identified by an SSB-Index.

In one embodiment, any RS resource in the first RS resource group is identified by an SS/PBCH block index.

In one embodiment, any RS resource in the first RS resource group is a CSI-RS resource or an SS/PBCH block resource.

In one embodiment, an RS resource comprises an RS port.

In one embodiment, an RS resource comprises a CSI-RS port.

In one embodiment, an RS resource comprises an antenna port.

In one embodiment, the second node transmits an RS in at least one RS resource in the first RS resource group; the first node receives an RS in at least one RS resource in the first RS resource group.

In one embodiment, the meaning of the phrase that the first CSI report configuration is associated with a first index includes: the first index is used to identify the first RS resource group.

### Embodiment 8

Embodiment 8 illustrates a schematic diagram of frequency-domain resources which a first CSI report is for comprise a first frequency-band resource group according to one embodiment of the present application, as shown in FIG. 8. In embodiment 8, the first CSI report configuration indicates a first frequency-band resource group, and frequency-domain resources which the first CSI report is for comprise the first frequency-band resource group.

In one embodiment, frequency-domain resources which the first CSI report is for is the first frequency-band resource group.

In one embodiment, the first CSI report configuration comprises a fifth higher-layer parameter, and the fifth higher-layer parameter indicates the first frequency-band resource group; a name of the fifth higher-layer parameter includes “csi-ReportingBand”.

In one embodiment, the fifth higher-layer parameter is “csi-ReportingBand”.

In one embodiment, the first frequency-band resource group comprises at least one sub-band.

In one embodiment, the first frequency-band resource group comprises multiple continuous sub-bands.

In one embodiment, the first frequency-band resource group comprises multiple discontinuous sub-bands.

In one embodiment, frequency-domain resources which the first CSI report is for comprise each sub-band in the first frequency-band resource group.

In one embodiment, frequency-domain resources which the first compress CSI is for comprise the first frequency-band resource group.

In one embodiment, frequency-domain resources which the first compress CSI is for is the first frequency-band resource group.

In one embodiment, the first compress CSI is used to determine at least one channel matrix for each sub-band in the first frequency-band resource group.

In one embodiment, the first compress CSI is used to determine at least one eigenvector for each sub-band in the first frequency-band resource group.

In one embodiment, the first compress CSI is used to determine at least one eigenvalue for each sub-band in the first frequency-band resource group.

In one embodiment, the first compress CSI is used to determine a precoding matrix for each sub-band in the first frequency-band resource group.

In one subembodiment of the above embodiment, the precoding matrix is non-codebook-based.

In one embodiment, the first CSI report comprises a CQI for each sub-band in the first frequency-band resource group.

In one embodiment, frequency-domain resources which the first pre-compress CSI is for comprise the first frequency-band resource group.

In one embodiment, the first pre-compress CSI comprises at least one channel matrix for each sub-band in the first frequency-band resource group.

In one embodiment, the first pre-compress CSI comprises information in at least one channel matrix for each sub-band in the first frequency-band resource group.

In one embodiment, the first pre-compress CSI comprises at least one eigenvector for each sub-band in the first frequency-band resource group.

In one embodiment, the first pre-compress CSI comprises information of at least one eigenvector for each sub-band in the first frequency-band resource group.

In one embodiment, the first pre-compress CSI comprises a CQI for each sub-band in the first frequency-band resource group.

In one embodiment, any sub-band in the first frequency-band resource group comprises at least one Physical Resource Block (PRB).

In one embodiment, the first frequency-band resource group belongs to a first BWP (Bandwidth Part).

In one embodiment, except for an outermost sub-band in the first BWP, a number of PRBs comprised in any sub-band in the first frequency-band resource group is P1, P1 being a positive integer greater than 1.

In one embodiment, P1 is a positive integral multiple of 4.

In one embodiment, P1 is one of 4, 8, 16, or 32.

In one embodiment, P1 is indicated by a higher-layer signaling.

In one embodiment, P1 is related to a number of PRB(s) comprised in the first BWP.

In one embodiment, if the first frequency-band resource group comprises a starting sub-band in the first BWP, a number of PRB(s) comprised in the starting sub-band is P1−(Ns mod P1); if the first frequency-band resource group comprises a last sub-band in the first BWP, a number of PRB(s) comprised in the last sub-band is (Ns+Nw) mod P1 or P1, where Ns is an index of a starting PRB in the first BWP and Nw is a number of PRB(s) comprised in the first BWP.

In one embodiment, a subcarrier spacing corresponding to a PRB or sub-band is fixed.

In one embodiment, a subcarrier spacing corresponding to a PRB or a sub-band varies with a frequency range to which the first frequency-band resource group belongs.

In one embodiment, a subcarrier spacing corresponding to a PRB or a sub-band is a subcarrier spacing of the first BWP.

In one embodiment, a bandwidth covered by the first frequency-band resource group is not greater than a first bandwidth threshold, and the first bandwidth threshold is related to the first index.

In one subembodiment of the above embodiment, the first index is used to determine the first bandwidth threshold.

In one subembodiment of the above embodiment, the first index is one of N indices, N being a positive integer greater than 1; the N indices correspond one-to-one with N bandwidth thresholds, and the first bandwidth threshold is a bandwidth threshold corresponding to the first index in the N bandwidth thresholds.

In one subembodiment of the above embodiment, the first index is related to a type or range of a radio channel to which a generator of the first compress CSI is applicable, and the first bandwidth threshold is associated with characteristics of a radio channel to which a generator of the first compress CSI is applicable.

In one reference embodiment of the above subembodiment, the first index is used to determine a type or range of a radio channel to which a generator of the first compress CSI is applicable.

In one subembodiment of the above embodiment, the first bandwidth threshold is associated with radio channel characteristics, so a type or range of a radio channel to which a generator of the first compress CSI is applicable can be indicated by the first bandwidth threshold.

In one embodiment, the first bandwidth threshold is measured by PRB.

In one embodiment, the first bandwidth threshold is measured by a positive integer number of PRB(s).

In one embodiment, the first bandwidth threshold is measured by 4 PRBs.

In one embodiment, the first bandwidth threshold is measured by 8 PRBs.

In one embodiment, the first bandwidth threshold is measured by sub-band.

In one embodiment, the first bandwidth threshold is measured by MHz.

In one embodiment, a generator of the first compress CSI comprises the first function.

### Embodiment 9

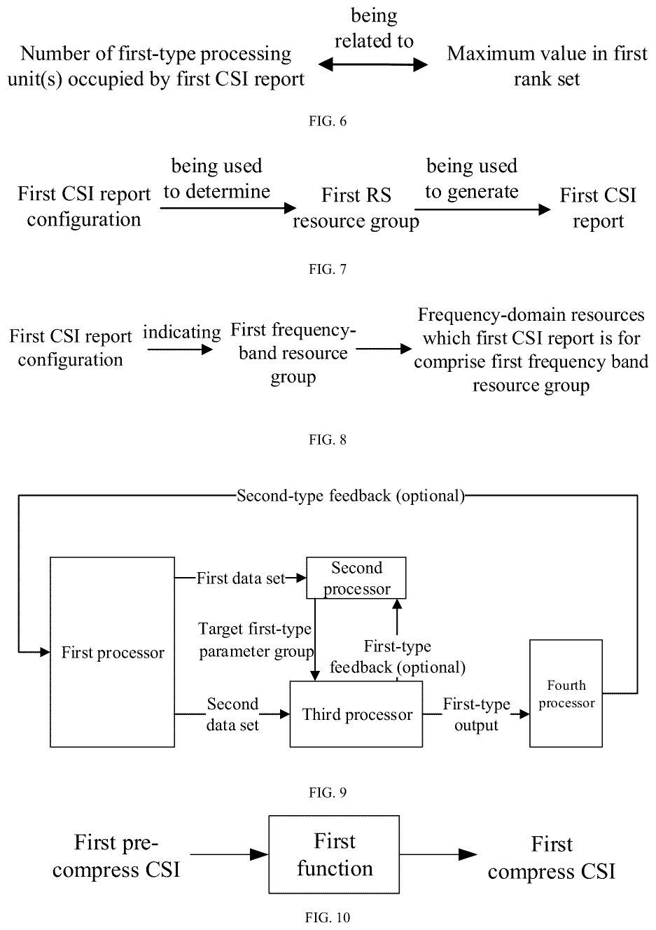

Embodiment 9 illustrates a schematic diagram of a processing system based on artificial intelligence or machine learning according to one embodiment of the present application, as shown in FIG. 9. FIG. 9 comprises a first processor, a second processor, a third processor, and a fourth processor. In embodiment 9, the first processor transmits a first data set to the second processor, and transmits a second data set to the third processor; the second processor generates a target first-type parameter set according to the first data set, and transmits the generated target first-type parameter set to the third processor; the third processor processes the second data set using the target first-type parameter set to acquire a first-type output, and the third processor transmits the first-type output to the fourth processor.

In one embodiment, the third processor transmits a first-type feedback to the second processor, and the first-type feedback is used to trigger a recalculation or update of the target first-type parameter group.

In one embodiment, the fourth processor transmits a second-type feedback to the first processor, the second-type feedback is used to generate the first data set or the second data set, or the second-type feedback is used to trigger a transmission of the first data set or second data set.

In one embodiment, the first processor generates the first data set and the second data set according to a measurement for a first-type radio signal, and the first-type radio signal comprises a downlink RS.

In one embodiment, a measurement of the first RS resource group is used to generate the second data set.

In one embodiment, the first processor and the third processor belong to the first node, and the fourth processor belongs to the second node.

In one embodiment, the first CSI report belongs to the first-type output.

In one embodiment, the first compress CSI belongs to the first-type output.

In one embodiment, the first pre-compress CSI belongs to the second data set.

In one embodiment, the second processor belongs to the first node.

The above embodiment avoids transmitting the first data set to the second node.

In one embodiment, the second processor belongs to the second node.

The above embodiments reduce the complexity of the first node.

In one embodiment, the first data set comprises training data, the second data set comprises inference data, the second processor is used for model training, and the trained model is described by the target first-type parameter set.

The description of the above training is applicable to the first function and the second function in the present application.

In one embodiment, the third processor constructs a model according to the target first-type parameter set, and then inputs the second data set into the constructed model to acquire the first-type output.

In one embodiment, the third processor comprises the first function.

In one embodiment, the first function is described by the target first-type parameter set.

In one embodiment, the target first-type parameter group is used to construct the first function.

In one embodiment, the first function is used to generate the first-type output.

In one embodiment, the third processor generates a recovered data set according to the first-type output, and an error between the recovered data set and the second data set is used to generate the first-type feedback.

In one subembodiment of the above embodiment, a generation of the recovered data set adopts an inverse operation similar to the target first-type parameter group.

In one embodiment, the first-type feedback is used to reflect the performance of the trained model; when the performance of the trained model cannot meet requirements, the second processing opportunity recalculates the target first-type parameter group.

In one embodiment, when the error is too large or has not been updated for too long, the performance of the trained model is considered unsatisfactory.

In one embodiment, the third processor belongs to the second node, and the first node reports the target first-type parameter group to the second node.

In one embodiment, the fourth processor comprises the second function.

In one embodiment, an input of the second function belongs to the first-type output.

### Embodiment 10

Embodiment 10 illustrates a schematic diagram of a first function according to one embodiment of the present application, as shown in FIG. 10. In embodiment 10, the first pre-compress CSI is used by the first node as an input to the first function to generate the first compress CSI.

In one embodiment, the first pre-compress CSI comprises a PMI.

In one embodiment, the first pre-compress CSI comprises one or multiple of a CQI, a CRI or an RI.

In one embodiment, the first pre-compress CSI comprises at least one channel matrix.

In one embodiment, the first pre-compress CSI comprises amplitude and phase information of an element in at least one channel matrix.

In one embodiment, the first pre-compress CSI comprises information of at least one channel matrix.

In one embodiment, the first pre-compress CSI comprises at least one eigenvector.

In one embodiment, the first pre-compress CSI comprises amplitude and phase information of an element in at least one eigenvector.

In one embodiment, the first pre-compress CSI comprises information of at least one eigenvector.

In one embodiment, the first pre-compress CSI is acquired by pre-processing at least one channel matrix.

In one embodiment, the pre-processing comprises DFT (Discrete Fourier Transform).

In one embodiment, the pre-processing comprises one or more of quantization, transformation from spatial domain to angular domain, transformation from frequency domain to time domain, transformation or truncation from time domain to frequency domain.

In one embodiment, a measurement of the first RS resource group is used to generate the first pre-compress CSI.

In one embodiment, a measurement of the first RS resource group is used to acquire a channel measurement for generating the first pre-compress CSI.

In one embodiment, the first pre-compress CSI comprises a first matrix, the first compress CSI comprises a second matrix, and a number of element(s) in the second matrix is less than a number of element(s) in the first matrix.

In one embodiment, the first pre-compress CSI is denoted by Q1 bits, and the first compress CSI is denoted by Q2 bits, Q1 and Q2 being positive integers greater than 1, and Q1 being greater than Q2.

In one embodiment, the first function is non-linear.

In one embodiment, the first function is non-codebook.

In one embodiment, an input of the first function comprises a CSI.

In one embodiment, an input of the first function comprises a channel matrix.

In one embodiment, an input of the first function comprises an eigenvector.

In one embodiment, an input of the first function comprises an uncompressed CSI.

In one embodiment, an output of the first function comprises a compressed CSI.

In one embodiment, a payload size of any input of the first function is greater than a payload size of an output of the any input corresponding to the first function.

In one embodiment, the first function is based on artificial intelligence or machine learning.

In one embodiment, the first function is based on neural network.

In one embodiment, the first function comprises neural network used for CSI compression.

In one embodiment, the first function comprises an encoder used for neural network for CSI compression.

In one embodiment, the first function comprises a CNN-based encoder used for CSI compression.

In one embodiment, the first function is obtained through training.

In one embodiment, the first function comprises K1 sub-functions, K1 being a positive integer greater than 1; the K1 sub-functions comprise one or more of convolution function, pooling function, cascading function, or activation function.

In one embodiment, there exists one of the K1 sub-functions comprising a fully-connected layer.

In one embodiment, there exists one of the K1 sub-functions comprising a pooling layer.

In one embodiment, there exists one of the K1 sub-functions comprising at least one convolutional layer.

In one embodiment, there exists one of the K1 sub-functions comprising at least one encoding layer.

In one embodiment, there exist two sub-functions in the K1 sub-functions respectively comprising a fully-connected layer and at least one encoding layer.

In one embodiment, an encoding layer comprises at least one convolutional layer and one pooling layer.

In one embodiment, at the convolutional layer, at least one convolutional kernel is used to convolve an input of the first function to generate a corresponding feature map, and the at least one feature map output from the convolutional layer is reshaped into a vector to be input to the fully-connected layer; the fully-connected layer converts the one vector into an output of the first function.

In one embodiment, encoders based on CsiNet or CRNet are used to implement the first function.

In one embodiment, for a detailed description of CsiNet, refer to Chao-Kai Wen, Deep Learning for Massive CSI Feedback, 2018 IEEE Wireless Communications Letters, vol. 7 No. 5, October 2018 et al.

In one embodiment, for a detailed description of CRNet, refer to Zhilin Lu, Multi-resolution CSI Feedback with Deep Learning in Massive MIMO System, 2020 IEEE International Conference on Communications (ICC) et al.

In one embodiment, the first function is indicated to the first node by a target receiver of the first information block.

In one embodiment, the first function is determined by the first node itself.

In one embodiment, the first function is used to generate any CSI report for the first CSI report configuration.

In one embodiment, the first function is used to generate a compress CSI for any CSI report for the first CSI report configuration.

In one embodiment, the first function is used to generate any CSI report for any CSI report configuration in the first CSI report configuration set.

In one embodiment, the first function is used to generate a compress CSI comprised in any CSI report for any CSI report configuration in the first CSI report configuration set.

In one embodiment, a number of transmitting RS port(s) corresponding to any input of the first function is not greater than a first port size threshold, and the first port size threshold is a positive integer.

In one embodiment, the first port size threshold is configurable.

In one embodiment, the first port size threshold is configured for the first function.

### Embodiment 11

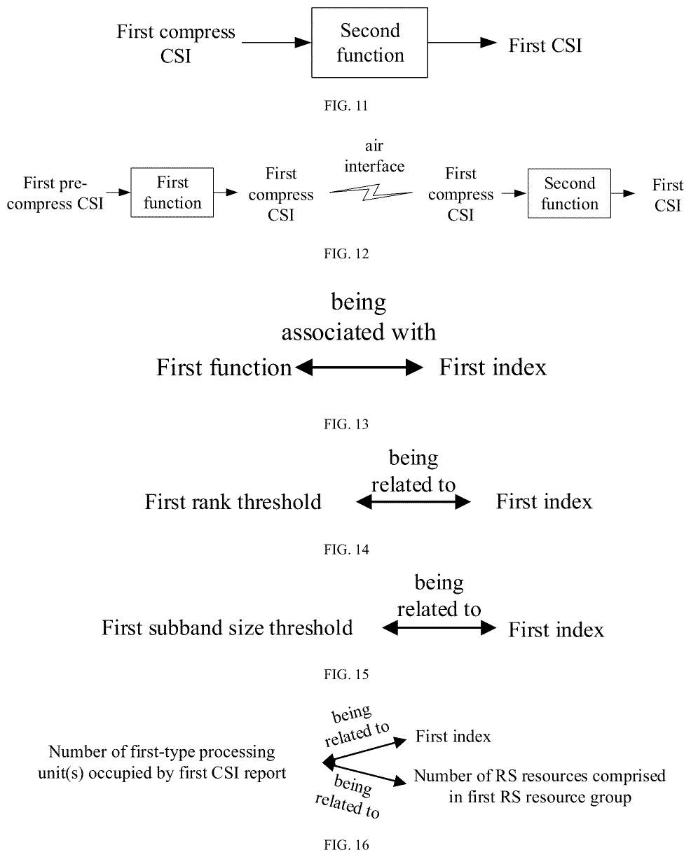

Embodiment 11 illustrates a schematic diagram of a second function according to one embodiment of the present application, as shown in FIG. 11. In embodiment 11, the first compress CSI is used as input of the second function to generate a first CSI.

In one embodiment, the first compress CSI is used as an input of the second function by the second node to generate the first CSI.

In one embodiment, the first compress CSI is used as an input of the second function by the first node to generate the first CSI.

In one embodiment, the first CSI comprises a PMI.

In one embodiment, the first CSI comprises one or multiple of a CQI, a CRI or an RI.

In one embodiment, the first CSI comprises at least one channel matrix.

In one embodiment, the first CSI comprises information of at least one channel matrix.

In one embodiment, the first CSI comprises at least one eigenvector.

In one embodiment, the first CSI comprises information of at least one eigenvector.

In one embodiment, the second function is non-linear.

In one embodiment, the second function is non-codebook.

In one embodiment, an input of the second function comprises a compressed CSI.

In one embodiment, an output of the second function comprises a recovered and uncompressed CSI.

In one embodiment, the second function is based on artificial intelligence or machine learning.

In one embodiment, the second function is based on a neural network.

In one embodiment, the second function comprises a neural network used for CSI compression.

In one embodiment, the second function comprises a decoder for a neural network used for CSI compression.

In one embodiment, the second function comprises a CNN-based decoder used for CSI compression.

In one embodiment, a decoder based on CsiNet or CRNet is used to implement the second function.

In one embodiment, the second function is obtained through training.

In one embodiment, the second function comprises K2 sub-functions, K2 being a positive integer greater than 1.

In one embodiment, the K2 sub-functions comprise one or more of convolutional function, pooling function, cascading function, or activation function.

In one embodiment, there exists one of the K2 sub-functions comprising a pre-processing layer.

In one subembodiment of the above embodiment, the pre-processing layer comprises a fully-connected layer.

In one subembodiment of the above embodiment, the pre-processing layer expands a size of an input of the second function.

In one embodiment, there exists one of the K2 sub-functions comprising a pooling layer.

In one embodiment, there at least exist one of the K2 sub-functions comprising at least one convolutional layer.

In one embodiment, there at least exist one of the K2 sub-functions comprising at least one decoding layer.

In one embodiment, the decoding layer comprises at least one convolutional layer.

In one embodiment, the decoding layer comprises at least one convolutional layer and one pooling layer.

In one embodiment, there exists one of the K2 sub-functions comprising a pre-processing layer, and there exists at least another one of the K2 sub-functions comprising at least one decoding layer.

### Embodiment 12

Embodiment 12 illustrates a schematic diagram of relations among a first pre-compress CSI, a first compress CSI, a first function and a second function according to one embodiment of the present application, as shown in FIG. 12. In embodiment 12, the first pre-compress CSI is used by the first node as an input of the first function to generate the first compress CSI, and the first compress CSI is used by the second node as an input of the second function to generate the first CSI.

In one embodiment, the first CSI comprises a recovery value of the first pre-compress CSI.

In one embodiment, the first CSI comprises an estimation value of the first pre-compress CSI.

In one embodiment, the first CSI comprises all or partial information of the first pre-compress CSI.

In one embodiment, the first compress CSI is transmitted by the first node and received by the second node via an air interface.

In one embodiment, the first compress CSI is transmitted by the first node after being quantized and received by the second node via an air interface.

In one embodiment, the first function is used to compress the first pre-compress CSI to reduce the radio overhead of the first compress CSI, and the second function is used to decompress the first compress CSI to recover the first pre-compress CSI as much as possible.

In one embodiment, the first node obtains a first channel matrix based on a measurement of an RS received in the first RS resource group; the first channel matrix is used to generate the first pre-compress CSI.

In one subembodiment of the above embodiment, any element in the first channel matrix comprises information about a channel experienced by an RS transmitted on an RS port in the first RS resource group on a frequency unit.

In one reference embodiment of the above embodiment, the frequency unit is a sub-band.

In one reference embodiment of the above embodiment, the frequency unit is a PRB.

In one reference embodiment of the above embodiment, the frequency unit consists of multiple continuous PRBs.

In one subembodiment of the above embodiment, the first pre-compress CSI comprises the first channel matrix.

In one subembodiment of the above embodiment, the first pre-compress CSI comprises at least one eigenvector of the first channel matrix.

In one subembodiment of the above embodiment, the first pre-compress CSI is acquired after the first channel matrix is through pre-processing.

In one subembodiment of the above embodiment, the first CSI comprises an estimate value of the first channel matrix.

In one subembodiment of the above embodiment, the first CSI comprises an estimate value of at least one eigenvector of the first channel matrix.

In one embodiment, the second function is an inverse function of the first function.

In one embodiment, the first function is established at the first node, and the second function is established at the second node.

In one embodiment, the first function is established at the first node and the second node at the same time, and the second function is established at the second node.

In one embodiment, the first function is established at the first node, and the second function is established at the first node and the second node at the same time.

In one embodiment, both the first function and the second function are established at the first node and the second node at the same time.

### Embodiment 13

Embodiment 13 illustrates a schematic diagram of a first function being associated with a first index according to one embodiment of the present application, as shown in FIG. 13.

In one embodiment, the meaning of the first function being associated with the first index includes: the first index is used to identify the first function.

In one embodiment, the meaning of the first function being associated with the first index includes: configuration information of the first function comprises the first index.

In one embodiment, the meaning of the first function being associated with the first index includes: the first index is related to a type of a radio channel to which the first function is applicable.

In one embodiment, the meaning of the first function being associated with the first index includes: the first index is used to indicate a type of a radio channel to which the first function is applicable.

In one embodiment, the meaning of the first function being associated with the first index includes: a type of a radio channel to which the first function is applicable is used to determine the first index.

In one embodiment, a type of the radio channel comprises one or more of Dense Urban, Urban Macro, Urban Micro, or rural macro.

In one embodiment, a type of a radio channel comprises at least one of carrier frequency or frequency range.

In one embodiment, the meaning of the first function being associated with the first index includes: the first index is related to a range of a radio channel to which the first function is applicable.

In one embodiment, the meaning of the first function being associated with the first index includes: the first index is used to determine a range of a radio channel to which the first function is applicable.

In one embodiment, the meaning of the first function being associated with the first index includes: the first index is used to indicate a range of a radio channel to which the first function is applicable.

In one embodiment, the meaning of the first function being associated with the first index includes: a range of a radio channel to which the first function is applicable is used to determine the first index.

In one embodiment, the first index is used by the first node to determine a type or range of a radio channel to which the first function is applicable.

In one embodiment, a type or range of a radio channel to which the first function is applicable is used by the second node to determine the first index.

In one embodiment, a range of the radio channel comprises one or more of a bandwidth range of a radio channel, a range of a number of sub-band(s) comprised, a range of a number of transmitting port(s), a range of a number of receiving port(s), a range of a number of multi-path(s), a range of delay spread, a range of Doppler spread, a range of Doppler shift, a range of average delay, a range of carrier frequency, frequency Range, or whether it includes a Line of Sight (LOS) path.

In one embodiment, a range of a radio channel to which the first function is applicable comprises one or more of a bandwidth range of frequency-domain resources which an input of the first function is for, a range of a number of sub-band(s) comprised in frequency-domain resources which an input of the first function is for, a range of a number of multi-path(s) corresponding to an input of the first function, a range of a number of transmitting port(s) corresponding to an input of the first function, a range of a number of receiving port(s) corresponding to an input of the first function, a range of a number of eigenvector(s) per sub-band comprised in an input of the first function, or a range of layer(s) corresponding to an input of the first function.

In one embodiment, a range of a radio channel to which the first function is applicable comprises one or more of a bandwidth range of frequency-domain resources which an output of the first function is for, a number of sub-band(s) comprised in frequency-domain resources which an output of the first function is for, or a range of layer(s) corresponding to an output of the first function.

In one embodiment, the meaning of the first function being associated with the first index includes: the first index is used to determine at least one of a bandwidth of frequency-domain resources which an input of the first function is for, a number of sub-band(s) comprised in frequency-domain resources which an input of the first function is for, a number of multi-path path(s) corresponding to an input of the first function, a number of transmitting port(s) corresponding to an input of the first function, a number of receiving port(s) corresponding to an input of the first function, a number of eigenvector(s) per sub-band comprised in an input of the first function, or a number of layer(s) corresponding to an input of the first function.

In one embodiment, the meaning of the first function being associated with the first index includes: the first index is used to determine at least one of a bandwidth of frequency-domain resources which an output of the first function is for, a number of sub-band(s) comprised in frequency-domain resources which an output of the first function is for, or a number of layer(s) corresponding to an output of the first function.

In one embodiment, the meaning of the phrase that a number of the first-type processing unit(s) occupied by the first CSI report is related to the first index includes: the number of the first-type processing unit(s) occupied by the first CSI report is related to a type of a radio channel to which the first function is applicable.

In one embodiment, the meaning of the phrase that a number of the first-type processing unit(s) occupied by the first CSI report is related to the first index includes: a type of a radio channel to which the first function is applicable is used to determine the number of the first-type processing unit(s) occupied by the first CSI report.

In one embodiment, the meaning of the phrase that a number of the first-type processing unit(s) occupied by the first CSI report is related to the first index includes: the number of the first-type processing unit(s) occupied by the first CSI report is related to a range of a radio channel to which the first function is applicable.

In one embodiment, the meaning of the phrase that a number of the first-type processing unit(s) occupied by the first CSI report is related to the first index includes: a range of a radio channel to which the first function is applicable is used to determine the number of the first-type processing unit(s) occupied by the first CSI report.

In one embodiment, the first function is one of N candidate functions, the N candidate functions correspond one-to-one with N indices, and the first index is an index corresponding to the first function among the N indices.

In one subembodiment of the above embodiment, the N candidate functions correspond to N integers respectively, and the number of the first-type processing unit(s) occupied by the first CSI report is equal to an integer corresponding to the first function among the N integers.

In one reference embodiment of the above subembodiment, the N integers are respectively N positive integers.

In one reference embodiment of the above subembodiment, there exist two different integers in the N integers.

In one subembodiment of the above embodiment, there exist types of radio channels to which two of the N candidate functions are applicable being different.

In one subembodiment of the above embodiment, there exist ranges of radio channels to which two of the N candidate functions are applicable being different.

In one subembodiment of the above embodiment, types of radio channels to which any two of the N candidate functions are applicable are different.

In one subembodiment of the above embodiment, ranges of radio channels to which any two of the N candidate functions are applicable are different.

In one subembodiment of the above embodiment, the N indices are different from each other.

In one embodiment, the meaning of the phrase that a number of the first-type processing unit(s) occupied by the first CSI report is related to the first index includes: the first function corresponds to a first integer, the first integer being a positive integer; the number of the first-type processing unit(s) occupied by the first CSI report is equal to the first integer.

In one embodiment, the first integer is configurable.

In one embodiment, a higher-layer signaling is used to configure the first integer.

In one embodiment, a higher-layer signaling is used to indicate that the first function corresponds to the first integer.

In one embodiment, configuration information of the first function comprises the first integer.

In one embodiment, a third information block is used to determine the first function, and the third information block indicates the first index.

In one subembodiment of the above embodiment, the third information block indicates the first integer.

In one subembodiment of the above embodiment, the third information block indicates that the first function corresponds to the first integer.

In one subembodiment of the above embodiment, the third information block indicates a model used to construct the first function, and the model is acquired based on training.

In one subembodiment of the above embodiment, the third information block indicates the target first-type parameter set in embodiment 9, and the first function is described by the target first-type parameter set.

In one subembodiment of the above embodiment, a transmitter of the third information block is the first node, and a target receiver of the third information block comprises the second node.

In one subembodiment of the above embodiment, a transmitter of the third information block is the second node, and a target receiver of the third information block comprises the first node.

In one embodiment, a fourth information block indicates that the first CSI report configuration is associated with the first function, and the fourth information block indicates the first index.

In one subembodiment of the above embodiment, the fourth information block indicates the first integer.

In one subembodiment of the above embodiment, the fourth information block is carried by at least one field of the first CSI report configuration.

In one subembodiment of the above embodiment, the fourth information block is carried by a higher-layer signaling.

In one subembodiment of the above embodiment, the meaning of the phrase that the first CSI report configuration is associated with the first function includes: the first function is used to generate a CSI report for the first CSI report configuration.

In one subembodiment of the above embodiment, the meaning of the phrase that the first CSI report configuration is associated with the first function includes: the first function is used to generate a compress CSI comprised in a CSI report for the first CSI report configuration.

In one embodiment, a fifth information block indicates that the first RS resource group is associated with the first function, and the fifth information block indicates the first index.

In one subembodiment of the above embodiment, the fifth information block indicates the first integer.

In one subembodiment of the above embodiment, the meaning of the phrase that the first RS resource group is associated with the first function includes: a measurement of the first RS resource group is used to generate an input of the first function.

In one subembodiment of the above embodiment, the meaning of the phrase that the first RS resource group is associated with the first function includes: the first function is used compress a CSI generated based on a measurement of the first RS resource group.

In one subembodiment of the above embodiment, the meaning of the phrase that the first RS resource group is associated with the first function includes: the first function is used to compress a CSI generated based on a channel measurement acquired from the first RS resource set.

In one embodiment, a sixth information block indicates a third RS resource group, and a measurement for the third RS resource group is used to generate training data for training the first function, and the sixth information block indicates the first index.

In one subembodiment of the above embodiment, a measurement for the third RS resource group is used to generate the first data set in embodiment 9.

In one subembodiment of the above embodiment, the sixth information block indicates the first integer.

In one subembodiment of the above embodiment, the sixth information block indicates: training data generated based on a measurement of the third RS resource group is used for training to construct the first function.

In one subembodiment of the above embodiment, the sixth information block indicates: the target first-type parameter set generated according to a measurement for the third RS resource group is used to construct the first function.

### Embodiment 14

Embodiment 14 illustrates a schematic diagram of a first rank threshold being related to a first index according to one embodiment of the present application, as shown in FIG. 14. In embodiment 14, the first CSI report indicates the first rank, the first rank is not greater than the first rank threshold, and the first rank threshold is related to the first index.

In one embodiment, the meaning of the phrase that a number of the first-type processing unit(s) occupied by the first CSI report is related to the first index includes: the first rank threshold is related to the first index, and the number of the first-type processing unit(s) occupied by the first CSI report is related to the first rank threshold.

In one embodiment, the first index is used to determine the first rank threshold.

In one embodiment, the first CSI report configuration is associated with the first index, and the first CSI report configuration is used to determine the first rank threshold.

In one subembodiment of the above embodiment, the first CSI report configuration indicates a first rank set, and the first rank belongs to the first rank set; the first rank threshold is equal to a maximum value in the first rank set.

In one embodiment, the first function is associated with the first index, and the first rank threshold is related to the first function.

In one embodiment, the first function is associated with the first index, and the first rank threshold is related to a type or range of a radio channel to which the first function is applicable.

In one embodiment, the first function is associated with the first index, and the first rank threshold is associated with properties of a radio channel to which the first function is applicable.

In one embodiment, the first rank threshold is associated with properties of a radio channel, so a type or range of a radio channel to which the first function is applicable can be indicated by the first rank threshold.

In one embodiment, the first rank threshold is used to determine the number of the first-type processing unit(s) occupied by the first CSI report.

In one embodiment, the number of the first-type processing unit(s) occupied by the first CSI report varies with the first rank threshold.

In one embodiment, the number of the first-type processing unit(s) occupied by the first CSI report increases with the increase of the first rank threshold.

In one embodiment, the number of the first-type processing unit(s) occupied by the first CSI report is linearly correlated with the first rank threshold, and a linear coefficient between the number of the first-type processing unit(s) occupied by the first CSI report and the first rank threshold is a positive real number.

In one embodiment, the number of the first-type processing unit(s) occupied by the first CSI report is equal to the first rank threshold.

In one embodiment, when the first rank threshold is equal to A1, the number of the first-type processing unit(s) occupied by the first CSI report is equal to B1; when the first rank threshold is equal to A2, the number of the first-type processing unit(s) occupied by the first CSI report is equal to B2; the A1 is greater than the A2, and the B1 is not less than the B2.

In one embodiment, the first rank is a positive integer.

In one embodiment, the first rank is a positive integer not greater than 2.

In one embodiment, the first rank is a positive integer not greater than 4.

In one embodiment, the first rank is a positive integer not greater than 8.

In one embodiment, the first rank is a rank.

In one embodiment, the first rank is a number of layer(s).

In one embodiment, the first CSI report comprises an RI, and the RI indicates the first rank.

In one embodiment, the rank refers to rank.

In one embodiment, the rank refers to a number of layer(s).

In one embodiment, the first rank threshold is a positive integer.

In one embodiment, the first rank threshold is a positive integer greater than 1.

In one embodiment, the first rank threshold is one of 2, 4, 6, or 8.

In one embodiment, the first rank threshold is configurable.

In one embodiment, the first rank threshold is configured by a higher-layer signaling.

In one embodiment, the first rank threshold does not need to be configured.

In one embodiment, the first rank threshold is default.

In one embodiment, the first rank threshold is configured for the first index.

In one embodiment, the first rank threshold is configured for the first function.

In one embodiment, the first rank threshold is indicated by the first CSI report configuration.

In one embodiment, the first rank threshold is a maximum value in candidate values for the first rank.

In one embodiment, the first rank threshold is a maximum candidate value of a rank indicated by any CSI report of the first CSI report configuration.

In one embodiment, the first rank threshold is a maximum candidate value for a rank indicated by any CSI report for any CSI report configuration in the first CSI report configuration set.

In one embodiment, the meaning of the phrase that the first rank threshold is related to the first index includes: the first rank threshold is related to the first function.

In one embodiment, a given CSI report is a CSI report generated by any of the first functions, and a rank indicated by the given CSI report is not greater than the first rank threshold.

In one subembodiment of the above embodiment, the first rank threshold is a maximum candidate value for a rank indicated by the given CSI report.

In one subembodiment of the above embodiment, the first function is used to generate the given CSI report.

In one subembodiment of the above embodiment, the first function is used to generate a compress CSI comprised in the given CSI report.

In one embodiment, the third information block or sixth information block in embodiment 13 indicates the first rank threshold.

In one embodiment, a rank indicated by a CSI report generated by the first function is not greater than the first rank threshold.

In one embodiment, a rank indicated by a CSI report generated by a function constructed based on training data generated by a measurement of the third RS resource group in embodiment 13 is not greater than the first rank threshold.

### Embodiment 15

Embodiment 15 illustrates a schematic diagram of a first sub-band number threshold being related to the first index according to one embodiment of the present application, as shown in FIG. 15. In embodiment 15, the first CSI report configuration indicates a first frequency-band resource group, and the first frequency-band resource group comprises at least one sub-band; frequency-domain resources which the first CSI report is for comprise the first frequency-band resource group; a number of sub-band(s) comprised in the first frequency-band resource group is not greater than a first sub-band number threshold, and the first sub-band number threshold is related to the first index.

In one embodiment, the meaning of the phrase that a number of the first-type processing unit(s) occupied by the first CSI report is related to the first index includes: the first sub-band number threshold is related to the first index, and the number of the first-type processing unit(s) occupied by the first CSI report is related to the first sub-band number threshold.

In one embodiment, the first index is used to determine the first sub-band number threshold.

In one embodiment, the first CSI report configuration is associated with the first index, and the first CSI report configuration is used to determine the first sub-band number threshold.

In one subembodiment of the above embodiment, the first CSI report configuration indicates the first sub-band number threshold.

In one embodiment, the first function is associated with the first index, and the first sub-band number threshold is related to the first function.

In one embodiment, the first function is associated with the first index, and the first sub-band number threshold is related to a type or range of a radio channel to which the first function is applicable.

In one embodiment, the first function is associated with the first index, and the first sub-band number threshold is associated with properties of a radio channel to which the first function is applicable.

In one embodiment, the first sub-band number threshold is associated with properties of a radio channel, so a type or range of a radio channel to which the first function is applicable can be indicated by the first sub-band number threshold.

In one embodiment, the first sub-band number threshold is used to determine the number of the first-type processing unit(s) occupied by the first CSI report.

In one embodiment, the number of the first-type processing unit(s) occupied by the first CSI report varies with the first sub-band number threshold.

In one embodiment, the number of the first-type processing unit(s) occupied by the first CSI report increases with the increase of the first sub-band number threshold.

In one embodiment, the number of the first-type processing unit(s) occupied by the first CSI report is linearly correlated with the first sub-band number threshold, and a linear coefficient between the number of the first-type processing unit(s) occupied by the first CSI report and the first sub-band number threshold is a positive real number.

In one embodiment, the number of the first-type processing unit(s) occupied by the first CSI report is equal to the first sub-band number threshold.

In one embodiment, when the first sub-band number threshold is equal to A1, the number of the first-type processing unit(s) occupied by the first CSI report is equal to B1; when the first sub-band number threshold is equal to A2, the number of the first-type processing unit(s) occupied by the first CSI report is equal to B2; the A1 is greater than the A2, and the B1 is not less than the B2.

In one embodiment, the first frequency-band resource group only comprises one sub-band.

In one embodiment, the first frequency-band resource group comprises multiple continuous sub-bands.

In one embodiment, the first frequency-band resource group comprises multiple discontinuous sub-bands.

In one embodiment, the first frequency-band resource group comprises at least one PRB.

In one embodiment, the first sub-band number threshold is a positive integer.

In one embodiment, the first sub-band number threshold is a positive integer not greater than 19.

In one embodiment, the first sub-band number threshold is a positive integer not greater than 100.

In one embodiment, the first sub-band number threshold is configurable.

In one embodiment, the first sub-band number threshold is configured for the first index.

In one embodiment, the first sub-band number threshold is configured for the first function.

In one embodiment, the first sub-band number threshold is indicated by the first CSI report configuration.

In one embodiment, the first sub-band number threshold is configured by a higher-layer signaling.

In one embodiment, the first sub-band number threshold is a largest candidate value of the number of sub-band(s) comprised in the first frequency-band resource group.

In one embodiment, the first sub-band number threshold is a largest candidate value for number of sub-band(s) comprised in frequency-domain resources to which any CSI report for the first CSI report configuration is for.

In one embodiment, a given CSI report configuration is any CSI report configuration in the first CSI report configuration set, and the first sub-band number threshold is a largest candidate value for a number of sub-band(s) comprised in frequency-domain resources which any CSI report for the given CSI report configuration is for.

In one embodiment, the meaning of the phrase that the first sub-band number threshold is related to the first index comprises: the first sub-band number threshold is related to the first function.

In one embodiment, a given CSI report is a CSI report generated by any the first function, and a number of sub-band(s) comprised in frequency-domain resources which the given CSI report is for is not greater than the first sub-band number threshold.

In one subembodiment of the above embodiment, the first sub-band number threshold is a maximum candidate value for a number of sub-band(s) comprised in frequency-domain resources which the given CSI report is for.

In one subembodiment of the above embodiment, the first function is used to generate the given CSI report or to generate a compress CSI comprised in the given CSI report.

In one embodiment, the third information block or sixth information block in embodiment 13 indicates the first sub-band number threshold.

In one embodiment, a number of sub-band(s) comprised in frequency-domain resources which a CSI report generated by the first function is for is not greater than the first sub-band number threshold.

In one embodiment, a number of sub-band(s) comprised in frequency-domain resources which a CSI report generated by a function constructed based on training data generated by a measurement of the third RS resource group in embodiment 13 is not greater than the first rank threshold.

### Embodiment 16

Embodiment 6 illustrate a schematic diagram of a number of first-type processing unit(s) occupied by a first CSI report being related to both a first index and a number of RS resources comprised in a first RS resource group according to one embodiment of the present application, as shown in FIG. 16.

In one embodiment, a measurement of the first RS resource group is used by the first node for acquiring a channel measurement for generating the first CSI report.

In one embodiment, a first higher-layer parameter comprised in the first CSI report configuration indicates the first RS resource group, and a name of the first higher-layer parameter includes “resourcesForChannelMeasurement”.

In one embodiment, the first RS resource group is identified by an NZP-CSI-RS-ResourceSetId or a CSI-SSB-ResourceSetId.

In one embodiment, any RS resource in the first RS resource group is a CSI-RS resource or an SS/PBCH block resource.

In one embodiment, the number of RS resources comprised in the first RS resource group is a positive integer not greater than 64.

In one embodiment, the number of RS resources comprised in the first RS resource group is a positive integer not greater than 128.

In one embodiment, the first index and the number of RS resources comprised in the first RS resource group are used together to determine the number of the first-type processing unit(s) occupied by the first CSI report.

In one embodiment, the number of the first-type processing unit(s) occupied by the first CSI report varies with the number of RS resources comprised in the first RS resource group.

In one embodiment, when the number of RS resources comprised in the first RS resource group is equal to C1, the number of the first-type processing unit(s) occupied by the first CSI report is equal to B1; when the number of RS resources comprised in the first RS resource group is equal to C2, the number of the first-type processing unit(s) occupied by the first CSI report is equal to B2; the C1 is greater than the C2, and the B1 is not less than the B2.

In one embodiment, the first rank threshold is related to the first index; the first rank threshold and the number of RS resources comprised in the first RS resource group are used together to determine the number of the first-type processing unit(s) occupied by the first CSI report.

In one embodiment, the number of the first-type processing unit(s) occupied by the first CSI report is linearly correlated with the first rank threshold and the number of RS resources comprised in the first RS resource group, respectively.

In one subembodiment of the above embodiment, linear coefficients between the number of the first-type processing unit(s) occupied by the first CSI report, the first rank threshold, and the number of RS resources comprised in the first RS resource group are positive real numbers, respectively.

In one embodiment, the number of the first-type processing unit(s) occupied by the first CSI report varies with the first rank threshold and with the number of RS resources comprised in the first RS resource group.

In one embodiment, the number of the first-type processing unit(s) occupied by the first CSI report varies with a maximum value of the first rank threshold and the number of RS resources comprised in the first RS resource group.

In one embodiment, the first CSI report indicates a first rank, and the first rank is related to the first index; the first rank and the number of RS resources comprised in the first RS resource group are used together to determine the number of the first-type processing unit(s) occupied by the first CSI report.

In one embodiment, the number of the first-type processing unit(s) occupied by the first CSI report is linearly correlated with the first rank and the number of RS resources comprised in the first RS resource group, respectively.

In one embodiment, the number of the first-type processing unit(s) occupied by the first CSI report varies with the first rank and with the number of RS resources comprised in the first RS resource group.

In one embodiment, the number of the first-type processing unit(s) occupied by the first CSI report varies with a maximum value of the first rank and the number of RS resources comprised in the first RS resource group.

In one embodiment, the first sub-band number threshold is related to the first index; the first sub-band number threshold and the number of RS resources comprised in the first RS resource group are used together to determine the number of the first-type processing unit(s) occupied by the first CSI report.

In one embodiment, a number of the first-type processing unit(s) occupied by the first CSI report is linearly correlated with the first sub-band number threshold and the number of RS resources comprised in the first RS resource group, respectively.

In one subembodiment of the above embodiment, linear coefficients between the number of the first-type processing unit(s) occupied by the first CSI report, the first sub-band number threshold, and the number of RS resources comprised in the first RS resource group are positive real numbers, respectively.

In one embodiment, the number of the first-type processing unit(s) occupied by the first CSI report varies with the first sub-band number threshold and with the number of RS resources comprised in the first RS resource group.

In one embodiment, the number of the first-type processing unit(s) occupied by the first CSI report varies with a maximum value of the first sub-band number threshold and the number of RS resources comprised in the first RS resource group.

In one embodiment, a bandwidth covered by the first frequency-band resource group is related to the first index; the bandwidth covered by the first frequency-band resource group and the number of RS resources comprised in the first RS resource group are used together to determine the number of the first-type processing unit(s) occupied by the first CSI report.

In one subembodiment of the above embodiment, the bandwidth covered by the first frequency-band resource group is a positive real number.

In one subembodiment of the above embodiment, the bandwidth covered by the first frequency-band resource group is denoted as a number of RB(s).

In one subembodiment of the above embodiment, the bandwidth covered by the first frequency-band resource group is denoted as a number of sub-band(s).

In one subembodiment of the above embodiment, the bandwidth covered by the first frequency-band resource group is measured by MHz or KHz.

In one embodiment, the number of the first-type processing unit(s) occupied by the first CSI report is linearly correlated with the bandwidth covered by the first frequency-band resource group and the number of RS resources comprised in the first RS resource group, respectively.

In one embodiment, the number of the first-type processing unit(s) occupied by the first CSI report varies with the bandwidth covered by the first frequency-band resource group and with the number of RS resources comprised in the first RS resource group.

In one embodiment, the number of the first-type processing unit(s) occupied by the first CSI report varies with a maximum value of the bandwidth covered by the first frequency-band resource group and the number of RS resources comprised in the first RS resource group.

In one embodiment, any RS resource in the first RS resource group comprises at least one RS port; a maximum number of RS port(s) comprised in RS resources in the first RS resource group is equal to a first value, and the first value is related to the first index; the first value and the number of RS resources comprised in the first RS resource group are used together to determine the number of the first-type processing unit(s) occupied by the first CSI report.

In one embodiment, the number of the first-type processing unit(s) occupied by the first CSI report is linearly correlated with the first value and the number of RS resources comprised in the first RS resource group, respectively.

In one subembodiment of the above embodiment, linear coefficients between the number of the first-type processing unit(s) occupied by the first CSI report, the first value, and the number of RS resources comprised in the first RS resource group are positive real numbers, respectively.

In one embodiment, the number of the first-type processing unit(s) occupied by the first CSI report varies with the first value and with the number of RS resources comprised in the first RS resource group.

In one embodiment, the number of the first-type processing unit(s) occupied by the first CSI report varies with a maximum value of the first value and the number of RS resources comprised in the first RS resource group.

### Embodiment 17

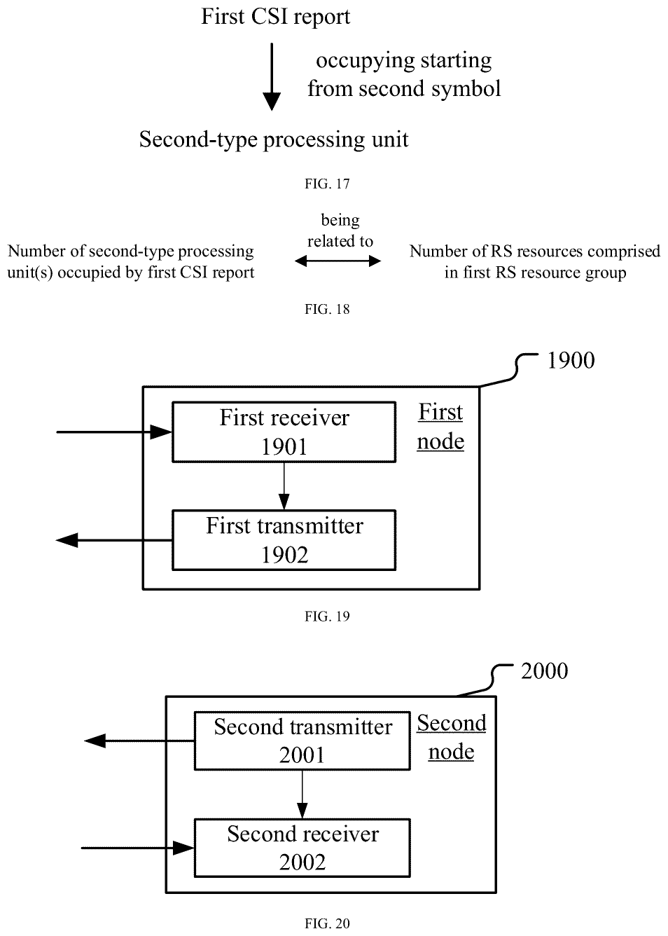

Embodiment 17 illustrates a schematic diagram of a first CSI report starting occupying a second-type processing unit from a second symbol according to one embodiment of the present application, as shown in FIG. 17.

In one embodiment, the second symbol is an OFDM symbol.

In one embodiment, the second symbol is the first symbol.

In one embodiment, the second symbol and the first symbol are a same symbol.

In one embodiment, the second symbol and the first symbol are two different symbols.

In one embodiment, the second symbol is earlier than the first symbol in time domain.

In one embodiment, the second symbol is later than the first symbol in time domain.

In one embodiment, the first symbol and the second symbol correspond to a same subcarrier spacing.

In one embodiment, the first CSI report does not occupy the second-type processing unit before the second symbol.

In one embodiment, the first CSI report does not occupy the first-type processing unit or the second-type processing unit before the second symbol.

In one subembodiment of the above embodiment, the second symbol is the first symbol.

In one subembodiment of the above embodiment, the second symbol is earlier than the first symbol in time domain.

In one embodiment, the second-type processing unit comprises a CSI processing unit.

In one embodiment, the second-type processing unit is a CSI processing unit.

In one embodiment, the second-type processing unit is a CSI processing unit, and the first-type processing unit is another type of processing unit different from a CSI processing unit.

In one embodiment, the second-type processing unit is used to process a first-type CSI report and a second-type CSI report; the first CSI report is the first-type CSI report; the first CSI report is not the second-type CSI report.

In one embodiment, the second-type processing unit is used to process a first-type CSI report and a second-type CSI report; the first-type processing unit is used to process only the first-type CSI report in the first-type CSI report and the second-type CSI report; the first CSI report is the first-type CSI report; the first CSI report is not the second-type CSI report.

In one embodiment, the first-type CSI report refers to a compress CSI.

In one embodiment, the second-type CSI report does not indicate a compress CSI.

In one embodiment, the second-type processing unit is used to process a CSI report quantity belonging to a first report quantity set in the first-type CSI report, and the first-type processing unit is used to process a CSI report quantity belonging to a second report quantity subset in the first-type CSI report.

In one embodiment, the first report quantity subset comprises CQI, PMI, CRI, LI, RI, SSBRI, L1-RSRP, and L1-SSINR.

In one embodiment, the first report quantity subset comprises a capability index or a capability set index.

In one embodiment, a PMI comprised in the first report quantity set comprises a PMI based on Type I single panel codebook, a PMI based on Type I multi-panel codebook, a PMI based on Type II codebook, a PMI based on Type II port selection codebook, a PMI based on enhanced Type II codebook, a PMI based on enhanced Type II port selection codebook, and a PMI based on further enhanced Type II port selection codebook.

In one embodiment, the second report quantity subset comprises a compressed CSI.

In one embodiment, the first-type CSI report comprises a CSI report quantity belonging to the first report quantity subset and a CSI report quantity belonging to the second report quantity subset; the second-type CSI report only comprises a CSI report quantity belonging to the first report quantity subset.

In one embodiment, the first-type processing unit and the second-type processing unit have different computing capabilities.

In one embodiment, the first-type processing unit and the second-type processing unit have different processing capabilities.

### Embodiment 18

Embodiment 18 illustrates a schematic diagram of a number of second-type processing unit(s) occupied by a first CSI report and a number of RS resources comprised in a first RS resource group according to one embodiment of the present application, as shown in FIG. 18.

In one embodiment, a number of the second-type processing unit(s) occupied by the first CSI report is related to a number of RS resources comprised in the first RS resource group in embodiment 7.

In one embodiment, the number of the second-type processing unit(s) occupied by the first CSI report is a positive integer.

In one embodiment, the number of the second-type processing unit(s) occupied by the first CSI report varies with the number of RS resources comprised in the first RS resource group.

In one embodiment, the number of the second-type processing unit(s) occupied by the first CSI report is linearly correlated with the number of RS resources comprised in the first RS resource group.

In one subembodiment of the above embodiment, a linear coefficient between the number of the second-type processing unit(s) occupied by the first CSI report and the number of RS resources comprised in the first RS resource group is a positive real number.

In one embodiment, the number of the second-type processing unit(s) occupied by the first CSI report is equal to the number of RS resources comprised in the first RS resource group.

In one embodiment, when the number of RS resources comprised in the first RS resource group is equal to C1, the number of the second-type processing unit(s) occupied by the first CSI report is equal to D1; when the number of RS resources comprised in the first RS resource group is equal to C2, the number of the second-type processing unit(s) occupied by the first CSI report is equal to D2; the C1 is greater than the C2, and the D1 is not less than the D2.

In one embodiment, the number of the second-type processing unit(s) occupied by the first CSI report is unrelated to the number of the first-type processing unit(s) occupied by the first CSI report.

In one embodiment, the number of the second-type processing unit(s) occupied by the first CSI report and the number of first-type processing unit(s) occupied by the first CSI report are respectively determined.

In one embodiment, the number of the second-type processing unit(s) occupied by the first CSI report is equal to the number of first-type processing unit(s) occupied by the first CSI report.

In one embodiment, the number of the second-type processing unit(s) occupied by the first CSI report is not equal to the number of first-type processing unit(s) occupied by the first CSI report.

In one embodiment, the number of the second-type processing unit(s) occupied by the first CSI report is unrelated to the first index.

In one embodiment, the first index is not used to determine the number of the second-type processing unit(s) occupied by the first CSI report.

In one embodiment, the number of the second-type processing unit(s) occupied by the first CSI report is unrelated to the first function.

In one embodiment, the number of the second-type processing unit(s) occupied by the first CSI report is unrelated to a range of a radio channel to which the first function is applicable.

In one embodiment, the number of the second-type processing unit(s) occupied by the first CSI report is unrelated to a maximum value in the first rank set.

In one embodiment, a maximum value in the first rank set is not used to determine the number of the second-type processing unit(s) occupied by the first CSI report.

In one embodiment, the number of the second-type processing unit(s) occupied by the first CSI report is unrelated to the first rank threshold.

In one embodiment, the first rank threshold is not used to determine the number of the second-type processing unit(s) occupied by the first CSI report.

In one embodiment, the number of the second-type processing unit(s) occupied by the first CSI report is unrelated to the first sub-band number threshold.

In one embodiment, the first sub-band number threshold is not used to determine the number of the second-type processing unit(s) occupied by the first CSI report.

In one embodiment, the number of the second-type processing unit(s) occupied by the first CSI report is unrelated to a bandwidth covered by the first frequency-band resource group.

In one embodiment, a bandwidth covered by the first frequency-band resource group is not used to determine the number of the second-type processing unit(s) occupied by the first CSI report.

In one embodiment, the number of the second-type processing unit(s) occupied by the first CSI report is unrelated to a maximum number of RS port(s) comprised in RS resources in the first RS resource group.

In one embodiment, a maximum number of RS port(s) comprised in RS resources in the first RS resource group is not used to determine the number of the second-type processing unit(s) occupied by the first CSI report.

### Embodiment 19

Embodiment 19 illustrates a structure block diagram of a processor in a first node according to one embodiment of the present application, as shown in FIG. 19. In FIG. 19, a processor 1900 in a first node comprises a first receiver 1901 and a first transmitter 1902.

In Embodiment 19, a first receiver 1901 receives a first CSI report configuration set; the first transmitter 1902 transmits a first information block.

In embodiment 19, the first CSI report configuration set comprises a first CSI report configuration, the first CSI report configuration is used to determine a first CSI report, and the first CSI report comprises a first compress CSI; the first information block comprises the first CSI report; the first CSI report configuration is associated with a first index; the first CSI report occupies a first-type processing unit starting from a first symbol, and a number of the first-type processing unit(s) occupied by the first CSI report is related to the first index.

In one embodiment, a first pre-compress CSI is used as an input of a first function to generate the first compress CSI.

In one embodiment, the meaning of the phrase that the first CSI report configuration is associated with a first index includes: the first function is associated with the first index.

In one embodiment, the first CSI report indicates a first rank, the first rank is not greater than a first rank threshold, and the first rank threshold is related to the first index.

In one embodiment, the first CSI report configuration indicates a first frequency-band resource group, and the first frequency-band resource group comprises at least one sub-band; frequency-domain resources which the first CSI report is for comprise the first frequency-band resource group; a number of sub-band(s) comprised in the first frequency-band resource group is not greater than a first sub-band number threshold, and the first sub-band number threshold is related to the first index.

In one embodiment, the first CSI report configuration is used to determine a first RS resource group, and a measurement of the first RS resource group is used to generate the first CSI report; the first RS resource group comprises at least one RS resource, and the number of the first-type processing unit(s) occupied by the first CSI report is related to both the first index and a number of RS resources comprised in the first RS resource group.

In one embodiment, the first CSI report occupies a second-type processing unit starting from a second symbol.

In one embodiment, the first receiver 1901 updates the first CSI report.

In one embodiment, the first transmitter 1902 updates the first CSI report.

In one embodiment, the first transmitter 1902 transmits the second information block.

In one embodiment, the first receiver 1901 updates the second CSI report.

In one embodiment, the first transmitter 1902 updates the second CSI report.

In one embodiment, the first node is a UE.

In one embodiment, the first node is a relay node.

In one embodiment, the first CSI report configuration is carried by a higher-layer signaling; the first symbol is an OFDM symbol.

In one embodiment, the first CSI report comprises an RI.

In one embodiment, the first CSI report comprises at least one CQI.

In one embodiment, the first CSI report configuration is used to determine a first RS resource group, and the first RS resource group only comprises one RS resource; a measurement of the first RS resource group is used to generate the first CSI report; the RS resource comprised in the first RS resource group is a CSI-RS resource or an SS/PBCH block resource.

In one embodiment, the first CSI report configuration indicates a first frequency-band resource group, and frequency-domain resources which the first CSI report is for comprise the first frequency-band resource group.

In one embodiment, the first receiver 1901 comprises at least one of the antenna 452, the receiver 454, the receiving processor 456, the multi-antenna receiving processor 458, the controller/processor 459, the memory 460, or the data source 467 in Embodiment 4.

In one embodiment, the first transmitter 1902 comprises at least one of the antenna 452, the transmitter 454, the transmitting processor 468, the multi-antenna transmitting processor 457, the controller/processor 459, the memory 460, or the data source 467 in Embodiment 4.

### Embodiment 20

Embodiment 20 illustrates a structure block diagram of a processor in a second node according to one embodiment of the present application, as shown in FIG. 20. In FIG. 20, a processor 2000 in a second node comprises a second transmitter 2001 and a second receiver 2002.

In embodiment 20, the second transmitter 2001 transmits a first CSI report configuration set; the second receiver 2002 receives a first information block.

In embodiment 20, the first CSI report configuration set comprises a first CSI report configuration, the first CSI report configuration is used to determine a first CSI report, and the first CSI report comprises a first compress CSI; the first information block comprises the first CSI report; the first CSI report configuration is associated with a first index; the first CSI report occupies a first-type processing unit starting from a first symbol, and a number of the first-type processing unit(s) occupied by the first CSI report is related to the first index.

In one embodiment, a first pre-compress CSI is used as an input of a first function to generate the first compress CSI.

In one embodiment, the meaning of the phrase that the first CSI report configuration is associated with a first index includes: the first function is associated with the first index.

In one embodiment, the first CSI report indicates a first rank, the first rank is not greater than a first rank threshold, and the first rank threshold is related to the first index.

In one embodiment, the first CSI report configuration indicates a first frequency-band resource group, and the first frequency-band resource group comprises at least one sub-band; frequency-domain resources which the first CSI report is for comprise the first frequency-band resource group; a number of sub-band(s) comprised in the first frequency-band resource group is not greater than a first sub-band number threshold, and the first sub-band number threshold is related to the first index.

In one embodiment, the first CSI report configuration is used to determine a first RS resource group, and a measurement of the first RS resource group is used to generate the first CSI report; the first RS resource group comprises at least one RS resource, and the number of the first-type processing unit(s) occupied by the first CSI report is related to both the first index and a number of RS resources comprised in the first RS resource group.

In one embodiment, the first CSI report occupies a second-type processing unit starting from a second symbol.

In one embodiment, a device in the second node is a base station.

In one embodiment, a device in the second node is a UE.

In one embodiment, a device in the second node is a relay node.

In one embodiment, the second receiver 2002 receives the second information block.

In one embodiment, the first CSI report configuration is carried by a higher-layer signaling; the first symbol is an OFDM symbol.

In one embodiment, the first CSI report comprises an RI.

In one embodiment, the first CSI report comprises at least one CQI.

In one embodiment, the first CSI report configuration is used to determine a first RS resource group, and the first RS resource group only comprises one RS resource; a measurement of the first RS resource group is used to generate the first CSI report; the RS resource comprised in the first RS resource group is a CSI-RS resource or an SS/PBCH block resource.

In one embodiment, the first CSI report configuration indicates a first frequency-band resource group, and frequency-domain resources which the first CSI report is for comprise the first frequency-band resource group.

In one embodiment, the second transmitter 2001 comprises at least one of the antenna 420, the transmitter 418, the transmitting processor 416, the multi-antenna transmitting processor 471, the controller/processor 475, or the memory 476 in Embodiment 4.

In one embodiment, the second receiver 2002 comprises at least one of the antenna 420, the receiver 418, the receiving processor 470, the multi-antenna receiving processor 472, the controller/processor 475, or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro-cellular base stations, micro-cellular base stations, Pico base stations, home base stations, relay base stations, eNB, gNB, Transmitter Receiver Points (TRPs), GNSS, relay satellites, satellite base stations, space base stations, RSUs, UAVs, test devices, such as a transceiver or a signaling tester that simulates some functions of a base station, and other wireless communication devices.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first CSI (Channel Status Information) report configuration set, the first CSI report configuration set comprising a first CSI report configuration, the first CSI report configuration being used to determine a first CSI report, the first CSI report comprising a first compress CSI; and
a first transmitter, transmitting a first information block, the first information block comprising the first CSI report;
wherein the first CSI report configuration is associated with a first index; the first CSI report occupies a first-type processing unit starting from a first symbol, and a number of the first-type processing unit(s) occupied by the first CSI report is related to the first index.

2. The first node according to claim 1, wherein a first pre-compress CSI is used as an input of a first function to generate the first compress CSI.

3. The first node according to claim 2, wherein the meaning of the phrase that the first CSI report configuration is associated with a first index includes: the first function is associated with the first index.

4. The first node according to claim 1, wherein the first CSI report indicates a first rank, the first rank is not greater than a first rank threshold, and the first rank threshold is related to the first index.

5. The first node according to claim 1, wherein the first CSI report configuration indicates a first frequency-band resource group, and the first frequency-band resource group comprises at least one sub-band; frequency-domain resources which the first CSI report is for comprise the first frequency-band resource group; a number of sub-band(s) comprised in the first frequency-band resource group is not greater than a first sub-band number threshold, and the first sub-band number threshold is related to the first index.

6. The first node according to claim 1, wherein the first CSI report configuration is used to determine a first RS (Reference Signal) resource group, and a measurement of the first RS resource group is used to generate the first CSI report; the first RS resource group comprises at least one RS resource, and the number of the first-type processing unit(s) occupied by the first CSI report is related to both the first index and a number of RS resources comprised in the first RS resource group.

7. The first node according to claim 1, wherein the first CSI report occupies a second-type processing unit starting from a second symbol.

8. A second node for wireless communications, comprising:
a second transmitter, transmitting a first CSI report configuration set, the first CSI report configuration set comprising a first CSI report configuration, the first CSI report configuration being used to determine a first CSI report, the first CSI report comprising a first compress CSI; and
a second receiver, receiving a first information block, the first information block comprising the first CSI report;
wherein the first CSI report configuration is associated with a first index; the first CSI report occupies a first-type processing unit starting from a first symbol, and a number of the first-type processing unit(s) occupied by the first CSI report is related to the first index.

9. The second node according to claim 8, wherein a first pre-compress CSI is used as an input of a first function to generate the first compress CSI, and the meaning of the phrase that the first CSI report configuration is associated with a first index includes: the first function is associated with the first index.

10. The second node according to claim 8, wherein the first CSI report indicates a first rank, the first rank is not greater than a first rank threshold, and the first rank threshold is related to the first index.

11. The second node according to claim 8, wherein the first CSI report configuration indicates a first frequency-band resource group, and the first frequency-band resource group comprises at least one sub-band; frequency-domain resources which the first CSI report is for comprise the first frequency-band resource group; a number of sub-band(s) comprised in the first frequency-band resource group is not greater than a first sub-band number threshold, and the first sub-band number threshold is related to the first index.

12. The second node according to claim 8, wherein the first CSI report configuration is used to determine a first RS resource group, and a measurement of the first RS resource group is used to generate the first CSI report; the first RS resource group comprises at least one RS resource, and the number of the first-type processing unit(s) occupied by the first CSI report is related to both the first index and a number of RS resources comprised in the first RS resource group.

13. The second node according to claim 8, wherein the first CSI report occupies a second-type processing unit starting from a second symbol.

14. A method in a first node for wireless communications, comprising:
receiving a first CSI report configuration set, the first CSI report configuration set comprising a first CSI report configuration, the first CSI report configuration being used to determine a first CSI report, the first CSI report comprising a first compress CSI; and
transmitting a first information block, the first information block comprising the first CSI report;
wherein the first CSI report configuration is associated with a first index; the first CSI report occupies a first-type processing unit starting from a first symbol, and a number of the first-type processing unit(s) occupied by the first CSI report is related to the first index.

15. The method according to claim 14, wherein a first pre-compress CSI is used as an input of a first function to generate the first compress CSI.

16. The method according to claim 15, wherein the meaning of the phrase that the first CSI report configuration is associated with a first index includes: the first function is associated with the first index.

17. The method according to claim 14, wherein the first CSI report indicates a first rank, the first rank is not greater than a first rank threshold, and the first rank threshold is related to the first index.

18. The method according to claim 14, wherein the first CSI report configuration indicates a first frequency-band resource group, and the first frequency-band resource group comprises at least one sub-band; frequency-domain resources which the first CSI report is for comprise the first frequency-band resource group; a number of sub-band(s) comprised in the first frequency-band resource group is not greater than a first sub-band number threshold, and the first sub-band number threshold is related to the first index.

19. The method according to claim 14, wherein the first CSI report configuration is used to determine a first RS resource group, and a measurement of the first RS resource group is used to generate the first CSI report; the first RS resource group comprises at least one RS resource, and the number of the first-type processing unit(s) occupied by the first CSI report is related to both the first index and a number of RS resources comprised in the first RS resource group.

20. The method according to claim 14, wherein the first CSI report occupies a second-type processing unit starting from a second symbol.
